(19) United States
(12) Patent Application Publication
(10) Pub. No.: US 2025/0126507 A1
(43) Pub. Date: Apr. 17, 2025

(54) DEVICE FOR SENSING INITIATION, DEVICE FOR SENSING RESPONDING, AND CHIP

(71) Applicant: GUANGDONG OPPO MOBILE TELECOMMUNICATIONS CORP., LTD., Dongguan (CN)

(72) Inventors: Ning GAO, Dongguan (CN); Lei HUANG, Singapore (SG); Chaoming LUO, Dongguan (CN)

(21) Appl. No.: 18/976,307

(22) Filed: Dec. 10, 2024

Related U.S. Application Data
(63) Continuation of application No. PCT/CN2022/112606, filed on Aug. 15, 2022.

(30) Foreign Application Priority Data
Jun. 13, 2022 (WO) PCT/CN2022/098487

(51) Int. Cl. H04W 24/10; H04B 7/06; H04W 52/52

(52) U.S. Cl. CPC H04W 24/10; H04B 7/0626; H04W 52/52

(57) ABSTRACT

Provided is a device for sensing initiation. The device includes a processor; a transceiver connected to the processor; and a memory, configured to store one or more executable instructions of the processor; wherein the processor, when loading and executing the one or more executable instructions, causes the device for sensing initiation to: transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

### CROSS-REFERENCE TO RELATED APPLICATION

This application is a continuation of International Application No. PCT/CN2022/112606, filed Aug. 15, 2022, which claims priority to International Application No. PCT/CN2022/098487, filed Jun. 13, 2022, the entire disclosures of which are incorporated herein by reference.

### TECHNICAL FIELD

The present disclosure relates to the field of sensing measurement, and in particular, relates to a device for sensing initiation, a device for sensing responding, and a chip.

### BACKGROUND

Wireless local area network (WLAN) sensing is a technique for sensing a human or an object in an environment by measuring changes in WLAN signals in the case that the WLAN signals are scattered and/or reflected by the human or the object.

### SUMMARY

Embodiments of the present disclosure provide a device for sensing initiation, a device for sensing responding, and a chip. The technical solutions are as follows.

According to an aspect of the present disclosure, a device for sensing initiation is provided. The device includes:
a processor;
a transceiver connected to the processor; and
a memory, configured to store one or more executable instructions of the processor;
wherein the processor, when loading and executing the one or more executable instructions, causes the device for sensing initiation to transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

According to an aspect of the present disclosure, a device for sensing responding is provided. The device includes:
a processor;
a transceiver connected to the processor; and
a memory, configured to store one or more executable instructions of the processor;
wherein the processor, when loading and executing the one or more executable instructions, causes the device for sensing responding to receive and/or transmit at least one frame carrying target information during a sensing measurement process, wherein the target information is related to at least one of a transmit power, a receive automatic gain control AGC gain, a transmit antenna radiation pattern, or a receive antenna radiation pattern.

According to an aspect of the present disclosure, a chip is provided. The chip includes a programmable logic circuitry or one or more programs. A sensing measurement device equipped with the chip is configured to transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic diagram of a sensing measurement system according to some embodiments of the present disclosure;

FIG. 2 is a schematic diagram of a sensing measurement process according to some embodiments of the present disclosure;

FIG. 3 is a schematic diagram of a sensing measurement process according to some embodiments of the present disclosure;

FIG. 4 is a flowchart of a WLAN sensing session in the related art;

FIG. 5 is a flowchart of trigger-based sensing measurement setup stage in the related art;

FIG. 6 is a flowchart of a trigger-based sensing measurement stage in the related art;

FIG. 7 is a flowchart of a trigger-based sensing report stage in the related art;

FIG. 8 is a flowchart of a based non-trigger sensing measurement setup stage in the related art;

FIG. 9 is a flowchart of a based non-trigger sensing measurement stage in the related art;

FIG. 10 is a schematic diagram of radio frequency and baseband modules of a Wi-Fi communication link in the related art;

FIG. 11 is a flowchart of a method for sensing measurement according to some embodiments of the present disclosure;

FIG. 12 is a flowchart of a method for sensing measurement according to some embodiments of the present disclosure;

FIG. 13 is a flowchart of a method for sensing measurement according to some embodiments of the present disclosure;

FIG. 14 is a schematic diagram of a sensing measurement parameter element according to some embodiments of the present disclosure;

FIG. 15 is a schematic diagram of a sensing measurement announcement frame according to some embodiments of the present disclosure;

FIG. 16 is a schematic diagram of a sensing measurement announcement frame according to some embodiments of the present disclosure;

FIG. 17 is a schematic diagram of a sensing measurement report element according to some embodiments of the present disclosure;

FIG. 18 is a flowchart of a method for sensing measurement according to some embodiments of the present disclosure;

FIG. 19 is a flowchart of a method for sensing measurement according to some embodiments of the present disclosure;

FIG. 20 is a flowchart of a method for sensing measurement according to some embodiments of the present disclosure;

FIG. 21 is a flowchart of a method for sensing measurement according to some embodiments of the present disclosure;

FIG. 22 is a flowchart of a method for sensing measurement according to some embodiments of the present disclosure;

FIG. 23 is a flowchart of a method for sensing measurement according to some embodiments of the present disclosure;

FIG. 24 is a flowchart of a method for sensing measurement according to some embodiments of the present disclosure;

FIG. 25 is a flowchart of a method for sensing measurement according to some embodiments of the present disclosure;

FIG. 26 is a flowchart of a method for sensing measurement according to some embodiments of the present disclosure;

FIG. 27 is a flowchart of a method for sensing measurement according to some embodiments of the present disclosure;

FIG. 28 is a structural block diagram of an apparatus for sensing initiation according to some embodiments of the present disclosure;

FIG. 29 is a structural block diagram of an apparatus for sensing responding according to some embodiments of the present disclosure; and

FIG. 30 is a schematic diagram of a device for sensing measurement according to some embodiments of the present disclosure.

### DETAILED DESCRIPTION

To make the purpose, technical solutions, and advantages of the present disclosure clearer, the following describes the embodiments of the present disclosure in detail in conjunction with the accompanying drawings. Illustrative embodiments are described herein in detail and shown in the accompanying drawings. In the case that the following description relates to the accompanying drawings, the same numerals in different accompanying drawings indicate the same or similar elements unless otherwise indicated. The implements described in the following illustrative embodiments do not represent all embodiments consistent with the present disclosure. Rather, these illustrative embodiments are only examples of apparatuses and methods consistent with some aspects of the present disclosure or as detailed in the appended claims.

The terms in the present disclosure are used only for the purpose of describing exemplary embodiments but are not intended to limit the present disclosure. The singular forms of “a,” “an,” and “the” as used in the present disclosure and the appended claims are also intended to encompass the plural form, unless the context clearly indicates a different meaning. It should also be understood that the phrase “and/or” as used herein refers to and encompasses any or all possible combinations of one or more of the associated listed items.

It should be understood that the terms “first,” “second,” “third,” and the like may be used in the present disclosure to describe various pieces of information, and such information should not be limited by these terms. These terms are used only to distinguish the same type of information. In some embodiments, without departing from the scope of the present disclosure, first information is referred to as second information in some embodiments, and similarly, second information is referred to as first information in some embodiments. Depending on the context, as used herein, the phrase “if” is interpreted as “at the time of . . . ,” “when . . . ,” or ‘in response to determining . . . . ”

First, some terms involved in embodiments of the present disclosure are described as follows.

An association identifier (AID) is configured to identify a terminal that has established an association with an access point.

WLAN sensing means sensing a human or an object in the environment by measuring changes in WLAN signals in the case that the WLAN signals are scattered and/or reflected by the human or object. That is, WLAN sensing is capable of implementing a plurality of functions, such as detecting whether a person is intruding/moving/falling indoors, recognizing gestures, or building a spatial three-dimensional image, by measuring and sensing the surrounding environment through wireless signals.

Sensing measurement by proxy means that a sensing measurement device requests one or more other sensing measurement devices other than itself to substitute the sensing measurement device itself to perform sensing measurement, e.g., an access point (AP) requests a station (STA) to substitute the AP itself to perform sensing measurement, or an STA requests an AP to substitute the STA itself to perform sensing measurements.

In some embodiments, WLAN devices involved in WLAN sensing include the following roles:
a sensing initiator, which is a device that initiates a sensing measurement and wants to be informed of a sensing result;
a sensing responder, which is a device participating in the sensing measurement but is not the sensing initiator;
a sensing signal transmitting device or sensing transmitter, which is a device that transmits a sensing measurement signal;
a sensing signal receiving device or sensing receiver, which is a device that receives a sensing measurement signal;
a proxy initiator (sensing-by-proxy initiator), also referred to as a proxy request device, which is a device that requests another device to initiate a sensing measurement; or
a proxy responder (sensing-by-proxy responder), also referred to as a sensing proxy device (sensing proxy STA) or a sensing proxy responding device, which is a device that responds to a request from a proxy initiator and initiates a sensing measurement.

The WLAN terminal is possible to play one or more roles in one sensing measurement. Illustrative, in some embodiments, a sensing initiator is only as the sensing initiator, or further as a sensing signal transmitting device, or further as a sensing signal receiving device, or as the sensing signal transmitting device and the sensing signal receiving device at the same time.

Next, the relevant technical background involved in embodiments of the present disclosure is described hereafter.

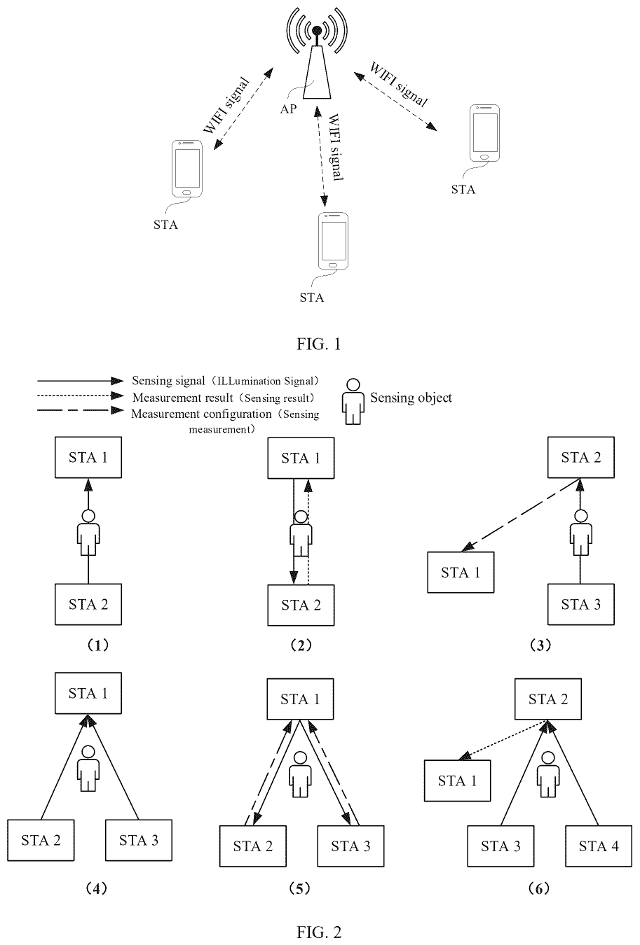

FIG. 1 is a block diagram of a sensing measurement system according to some embodiments of the present disclosure. The sensing measurement system includes terminals, a terminal and a network device, or an AP and an STA, which is not limited in the present disclosure. The present disclosure is illustrated with an example of the sensing measurement system including an AP and an STA.

In some scenarios, the AP is also referred to as an AP STA. That is, in a sense, the AP is also an STA. In some scenarios, the STA is referred to as a non-AP STA.

In some embodiments, an STA includes an AP STA and a non-AP STA.

Communication in a communication system is between an AP and a non-AP STA, between a non-AP STA and a non-AP STA, or between an STA and a peer STA, wherein the peer STA refers to a device that is in communication with the STA at an opposite end, the peer STA is an AP or a non-AP STA in some embodiments.

An AP is equivalent to a bridge between a wired network and a wireless network, and the main role of the AP is to connect individual wireless network clients together and then connect the wireless network to the Ethernet. In some embodiments, the AP device is a terminal (e.g., a cellphone) or a network device (e.g., a router) with a wireless-fidelity (Wi-Fi) chip.

It should be understood that the role of an STA in a communication system is not absolute. Illustratively, in some scenarios where a cellphone is connected to a router, the cellphone is a non-AP STA, and in some scenarios where the cellphone serves as a hotspot for other cellphones, the cell phone acts as an AP.

In some embodiments, APs and non-AP STAs are devices applied in the Internet of Vehicles, IoT nodes or sensors in the Internet of Things (IoT), smart cameras, smart remotes, smart water meters, or smart energy meters in smart homes, sensors in smart cities, or the like.

In some embodiments, the non-AP STA supports but is not limited to, the 802.11be standard. In some embodiments, the non-AP STA further supports a variety of current and future WLAN standards of the 802.11 family such as 802.11ax, 802.11ac, 802.11n, 802.11g, 802.11b, 802.11a, or the like.

In some embodiments, the AP is a device that supports the 802.11be standard. In some embodiments, the AP is a device that supports a variety of current and future WLAN standards of the 802.11 family such as 802.11ax, 802.11ac, 802.11n, 802.11g, 802.11b, 802.11a, or the like.

In some embodiments of the present disclosure, the STA is a mobile phone, a pad, a computer, a virtual reality (VR) device, an augmented reality (AR) device, a wireless device in an industrial control system, a set-top box, a wireless device in a self-driving system, an in-vehicle communication device, a wireless device in a remote medical system, a wireless device in a smart grid, a wireless device in a transportation safety system, a wireless device in a smart city, a wireless device in a smart home, a wireless communication chip/ASIC/SOC, or the like.

Frequency band supported by the WLAN technology includes but is not limited to a low-frequency band (2.4 GHz, 5 GHz, or 6 GHz) or a high-frequency band (60 GHz).

One or more links exist between the STA and the AP.

In some embodiments, the STA and the AP support multi-band communication, such as simultaneous communication on the 2.4 GHz, 5 GHz, 6 GHz, and 60 GHz bands or simultaneous communication on different channels in a same band (or different bands), thereby improving communication throughput and/or reliability between devices. Such devices are generally referred to as multi-band devices, as multi-link devices (MLDs), or as multi-link entities or multi-band entities in some embodiments. A multi-link device is an access point device or a station device. In the case that the multi-link device is an access point device, the multi-link device includes one or more APs; and in the case that the multi-link device is a station device, the multi-link device includes one or more non-AP STAs.

In some embodiments, a multi-link device including one or more APs is referred to as an AP, and a multi-link device including one or more non-AP STAs is referred to as a non-AP. In some embodiments, the non-AP is also referred to as an STA.

In some embodiments of the present disclosure, the AP includes a plurality of APs, the non-AP includes a plurality of STAs, a plurality of links are formed between any one or more of the plurality of APs in the AP and any one or more of the plurality of STAs in the Non-AP, and any one or more of the plurality of APs in the AP are communicated with the corresponding one or more STAs in the non-AP via the corresponding one or more links.

An AP is a device deployed in a wireless local area network (WLAN) to provide wireless communication functions for an STA. In some embodiments, a station includes a user equipment (UE), an access terminal, a subscriber unit, a subscriber station, a mobile station, a mobile terminal, a remote station, a remote terminal, a mobile device, a wireless communication device, a user agent, or a user device. In some embodiments, the station includes a cellular phone, a cordless telephone, a Session Initiation Protocol (SIP) telephone, a wireless local loop (WLL) station, a personal digital assistant (PDA), a handheld device with wireless communication functions, a computing device, other processing devices connected to a wireless modem, in-vehicle devices, or wearable devices, which are not limited in the embodiments of the present disclosure.

In the embodiments of the present disclosure, both the station and the access point support the IEEE 802.11 standard.

In a WLAN sensing scenario, a WLAN terminal involved in sensing includes a sensing session initiating device and a sensing session responding device. Alternatively, the WLAN terminal involved in sensing includes a sensing signal transmitting device and a sensing signal receiving device. In some embodiments, the sensing session initiating device is referred to as a sensing initiator device; and the sensing session responding device is referred to as a sensing responder device.

The sensing measurement is applicable to a cellular network communication system, a wireless local area network (WLAN) system, or a wireless fidelity (Wi-Fi) system, which is not limited in the embodiments of the present disclosure. The present disclosure is illustrated using an example in which the sensing measurements is applied in a WLAN or Wi-Fi system.

Parts (1) to (6) of FIG. 2 illustrate six typical scenarios of the sensing measurement based on a sensing signal according to some embodiments of the present disclosure.

In some embodiments, the sensing measurement is a one-way interactive process in which one station transmits a sensing signal to another station. As shown in part (1) of FIG. 2, the sensing measurement is a process of a station 2 transmitting the sensing signal to a station 1.

In some embodiments, the sensing measurement is an interactive process between two stations. As shown in part (2) of FIG. 2, the sensing measurement is a process that the station 1 transmits a sensing signal to the station 2 and the station 2 transmits a measurement result to the station 1.

In some embodiments, the sensing measurement is a combination of multiple one-way information interaction processes. As shown in part (3) of FIG. 2, the sensing measurement is a process that a station 3 transmits the sensing signal to the station 2 and the station 2 transmits the measurement configuration to the station 1.

In some embodiments, the sensing measurement is a process of multiple stations transmitting sensing signals to a single station separately. As shown in part (4) of FIG. 2, the sensing measurement is a process that the stations 2 and 3 transmit sensing signals to the station 1 separately.

In some embodiments, the sensing measurement is a process of one station performing information interaction with a plurality of other stations separately. As shown in part (5) of FIG. 2, the sensing measurement is a process that the station 1 transmits sensing signals to the station 2 and the station 3 separately, and the stations 2 and 3 transmit measurement configurations to the station 1 separately.

In some embodiments, as shown in part (6) of FIG. 2, the sensing measurement is a process that a plurality of stations (such as stations 3 and 4) transmit sensing signals to the station 2 separately, and the station 2 transmits a measurement result to the station 1.

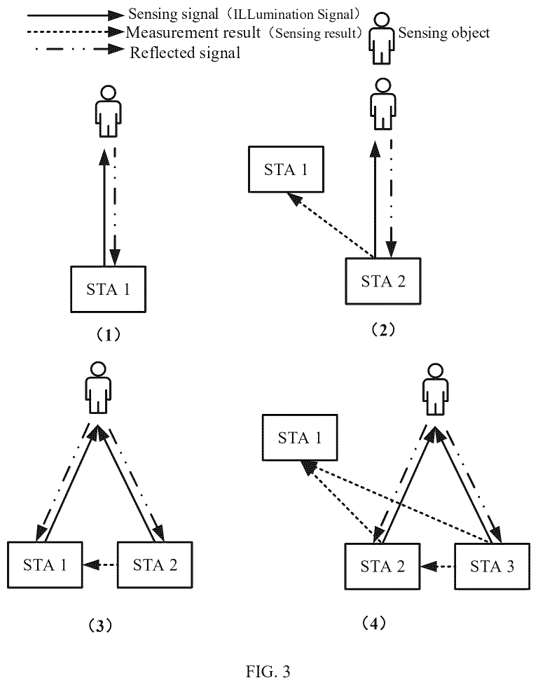

Parts (1) to (4) of FIG. 3 illustrate four typical scenarios of a sensing measurement based on a sensing signal and a reflected signal according to some embodiments of the present disclosure.

In some embodiments, as shown in part (1) of FIG. 3, a sensing signal transmitted by the station 1 reaches a sensing object, the sensing object reflects the sensing signal, and the station 1 receives the reflected signal.

In some embodiments, as shown in part (2) of FIG. 3, the sensing signal transmitted by the station 2 reaches a sensing object, the sensing object reflects the sensing signal, and the station 2 receives the reflected signal.

In some embodiments, as shown in part (3) of FIG. 3, both the sensing signals respectively transmitted by the station 1 and the station 2 reach a sensing object, the sensing object reflects the sensing signals transmitted by the station 1 and the station 2 separately, the station 1 and the station 2 respectively receive the signals reflected by the sensing object, and the station 2 transmits a measurement result to the station 1 (i.e., the measurement result is synchronized and shared between stations.)

In some embodiments, as shown in part (4) of FIG. 3, both the sensing signals respectively transmitted by the station 3 and the station 2 reach a sensing object, the sensing object reflects the sensing signals transmitted by the station 3 and the station 2 separately, the station 3 and the station 2 respectively receive the signals reflected by the sensing object, station 3 transmits a measurement result to the station 1 and the station 2 separately, and the station 2 transmits a measurement result to the station 1 (i.e., the measurement result is synchronized and shared between stations.)

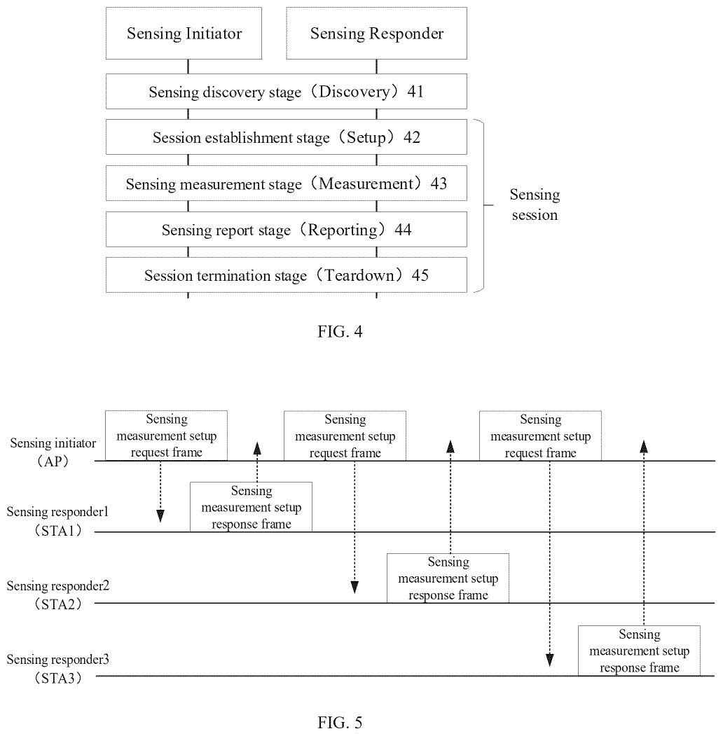

As shown in FIG. 4, the WLAN sensing session includes one or more of the following stages: a sensing discovery stage 41, a session establishment stage 42, a sensing measurement stage 43, a sensing report stage 44, and a session termination stage 45.

The sensing discovery stage 41 is configured for initiating a sensing session.

The session establishment stage 42 is configured for establishing the sensing session, determining the sensing session participants and their roles (including a sensing signal transmitting device and a sensing signal receiving device), determining an operational parameter related to the sensing session, and, in some embodiments, transmitting the parameter between terminals.

The sensing measurement stage 43 is configured for performing a sensing measurement, wherein the sensing signal transmitting device transmits a sensing signal to the sensing signal receiving device.

The sensing report stage 44 is configured for reporting a measurement result, which depends on the application scenario, and in some embodiments, the sensing receiving device needs to report the measurement result to the sensing measurement initiating device.

The session termination stage 45 is configured for a terminal stopping the measurement and terminating the sensing session.

In some embodiments, the same sensing measurement device plays one or more roles in a sensing session. In some embodiments, the sensing session initiating device is only as a sensing session initiating device, or further as a sensing signal transmitting device, or further as a sensing signal receiving device, or as the sensing signal transmitting device and the sensing signal receiving device at the same time.

In some embodiments, the sensing measurement process at least includes a Trigger-Based (TB) sensing measurement process and a Based Non-Trigger (Based Non-TB) sensing measurement process, wherein “Based Non-Trigger” is also referred to as “Non-Trigger-Based (Non-TB).”

### TB Sensing Measurement Process:

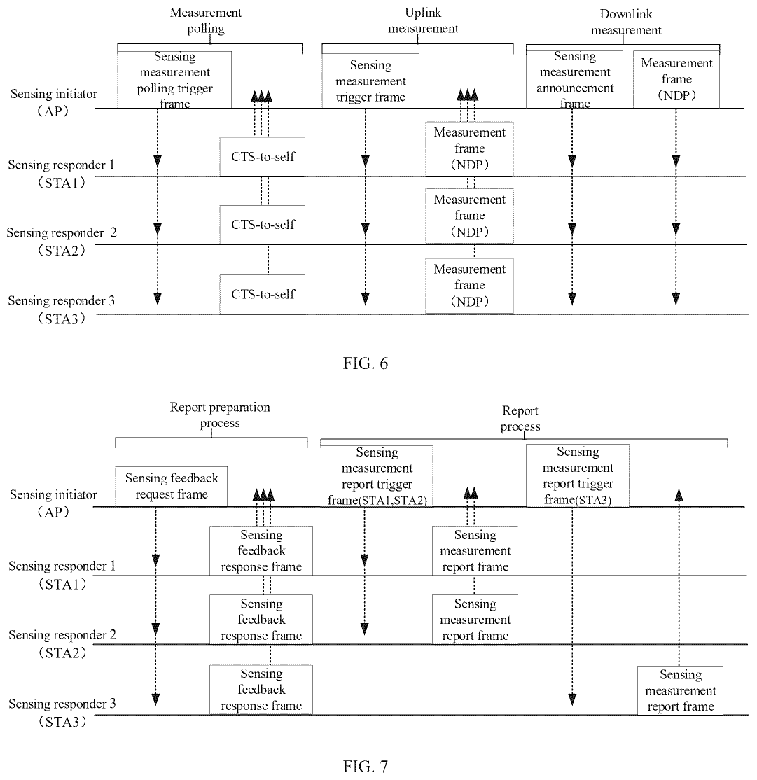

FIGS. 5 to 7 are flowcharts of a trigger-based measurement process which includes three stages: a sensing measurement setup stage (as shown in FIG. 5), a sensing measurement stage (as shown in FIG. 6), and a sensing report stage (as shown in FIG. 7).

As shown in FIG. 5, in the sensing measurement setup stage, a sensing initiator device (such as an AP) transmits sensing measurement setup request frames to a sensing responder device 1 (e.g., STA1), a sensing responder device 2 (e.g., STA2), and a sensing responder device 3 (e.g., STA3) separately, and the sensing responder device 1, the sensing responder device 2, and the sensing responder device 3 respectively return sensing measurement setup response frames to the sensing initiator device.

As shown in FIG. 6, the sensing measurement stage includes three parts, namely measurement polling, uplink measurement, and downlink measurement.
In the measurement polling process, the sensing initiator device transmits sensing measurement polling trigger frames to the sensing responder device 1, the sensing responder device 2, and the sensing responder device 3 separately, and the sensing responder device 1, the sensing responder device 2, and the sensing responder device 3 respond to the sensing measurement polling trigger frames from the sensing initiator device.
In the uplink measurement process, the sensing initiator device transmits sensing measurement trigger frames to the sensing responder device 1, the sensing responder device 2, and the sensing responder device 3 separately, and the sensing responder device 1, the sensing responder device 2, and the sensing responder device 3 transmit measurement frames (e.g., NDP) to the sensing initiator device.
In the downlink measurement process, the sensing initiator device transmits sensing measurement announcement frames to the sensing responder device 1, the sensing responder device 2, and the sensing responder device 3 separately, and then transmits measurement frames (e.g., NDP) to the sensing responder device 1, the sensing responder device 2, and the sensing responder device 3 separately.

CTS-to-self in FIG. 6 is a frame format defined in a relevant communication standard and is used in the present disclosure to represent a response to a sensing polling trigger frame.

As shown in FIG. 7, the sensing measurement report stage includes two parts: a report preparation process and a report process.
In the report preparation process, the sensing initiator device transmits sensing feedback request frames to the sensing responder device 1, the sensing responder device 2, and the sensing responder device 3 separately, and the sensing responder device 1, the sensing responder device 2, and the sensing responder device 3 return sensing feedback response frames to the sensing initiator device.
In the report process, the sensing initiator device transmits sensing measurement report trigger frames to the sensing responder device 1 and the sensing responder device 2 separately, and the sensing responder device 1 and the sensing responder device 2 return sensing measurement report frames to the sensing initiator device. The sensing initiator device transmits a sensing measurement report trigger frame to the sensing responder device 3, and the sensing responder device 3 returns a sensing measurement report frame to the sensing initiator device.

### Non-TB Sensing Measurement Process:

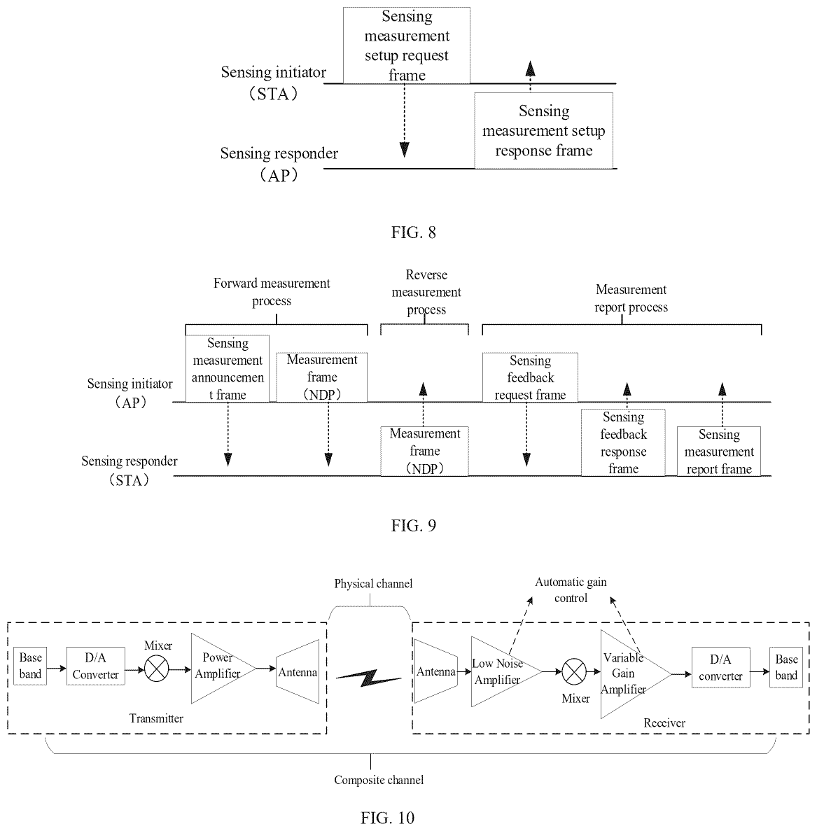

FIGS. 8 to 9 are flowcharts of a non-trigger-based measurement process which includes two stages: a sensing measurement setup stage (as shown in FIG. 8) and a sensing measurement report stage (as shown in FIG. 9).

As shown in FIG. 8, in the sensing measurement setup stage, a sensing initiator device (e.g., AP) transmits a sensing measurement setup request frame to a sensing responder device (e.g., STA), and the sensing responder device returns a sensing measurement setup response frame to the sensing initiator device.

As shown in FIG. 9, the sensing measurement report stage includes three parts, namely a forward measurement process, a reverse measurement process, and a measurement report process.
In the forward measurement process, the sensing initiator device transmits a sensing measurement announcement frame to the sensing responder device, and then transmits a measurement frame (e.g., NDP) to the sensing responder device.
In the reverse measurement process, the sensing responder device transmits a measurement frame (e.g., NDP) to the sensing initiator device.
In the measurement report process, the sensing initiator device transmits a sensing feedback request frame to the sensing responder device, the sensing responder device transmits a sensing feedback response frame to the sensing initiator device, and then the sensing responder device transmits a sensing measurement report frame to the sensing initiator device.

FIG. 10 is a schematic diagram of radio frequency (RF) and baseband (BB) modules of a Wi-Fi communication link, which include a Transmitter (Tx) and a Receiver (Rx.) The transmitter, according to a signal transmission sequence, includes a baseband, a digital-to-analog (D/A) converter (DAC), a mixer, a power amplifier (PA), and an antenna. The receiver, according to a signal reception sequence, includes an antenna, a low noise amplifier (LNA), a mixer, a variable gain amplifier (VGA), a D/A converter, and a baseband, wherein the LNA and VGA are used for automatic gain Control (AGC).

Wi-Fi/WLAN sensing is concerned with the physical channel between the antenna of the transmitter and the antenna of the receiver, and the physical channel is influenced by physical environments such as walls, floors, moving objects, and the like. However, Wi-Fi/WLAN devices are originally configured for transmitting data, and the relationship between the baseband symbols transmitted by the transmitter and the baseband symbols received by the receiver is concerned, such that the channel that is sensed by the original channel estimation function of the devices is a composite channel rather than a mere physical channel. The composite channel includes both a transmitting link in the transmitter and a transmitting link in the receiver, i.e., the composite channel is a complete link from the baseband of the transmitter to the baseband of the receiver, and is also referred to as a modulated channel in “Principles of Communication.” Therefore, in the case that Wi-Fi/WLAN is used to sense changes in the physical environment, changes in the transmit power and the transmit antenna radiation pattern of the transmitter during the period or changes in the receive gain (that is, the automatic gain control gain) and the receive antenna radiation pattern of the receiver result in interference with sensing of the physical channel itself and reduce the accuracy of sensing.

With respect to the above problems, the present disclosure provides improved solutions based on the contents of 11bf Draft 0.1. The improved solutions transmit relevant information through a number of modified or newly defined elements and frame formats during the sensing measurement setup, measurement, and report stages, to eliminate or compensate for interferences caused by changes in the transmit power, the transmit antenna radiation pattern, the AGC receive gain, or the receive antenna radiation pattern with the sensing measurement result.

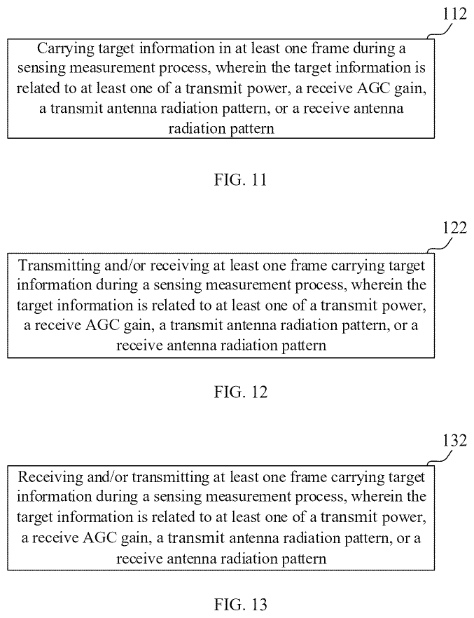

FIG. 11 is a flowchart of a method for sensing measurement according to some embodiments of the present disclosure. The method is applicable to a sensing initiator, a sensing responder, a sensing transmitter, or a sensing receiver. The method includes at least one of the following processes.

In process 112, target information is carried in at least one frame during a sensing measurement process, wherein the target information is related to at least one of a transmit power, a receive AGC gain, a transmit antenna radiation pattern, or a receive antenna radiation pattern.

In some embodiments, the target information is configured to eliminate or compensate for an impact of a change in at least one of the transmit power, the receive AGC gain, the transmit antenna radiation pattern, or the receive antenna radiation pattern on a sensing measurement result.

In some embodiments, carrying the target information in at least one frame during the sensing measurement includes at least one of:
carrying the target information in at least one frame of the sensing measurement setup stage;
carrying the target information in at least one frame of the sensing measurement stage; or
carrying the target information in at least one frame of the sensing measurement report stage.

In some embodiments, the target information is carried in at least one frame transmitted between a Physical (PHY) layer and a Medium Access Control (MAC) layer for transmission. In some embodiments, the above process includes at least one of:
carrying at least one of the following parameters in a PHY layer configuration vector carried in a PHY layer configuration request primitive:
an AGC constraint parameter; or
a receive antenna radiation pattern constraint parameter; or
carrying an AGC gain parameter in a receive vector transmitted from the PHY layer to the MAC layer.

In summary, in the method for sensing measurement according to the embodiments, by carrying target information related to at least one of the transmit power, the receive AGC gain, the transmit antenna radiation pattern, or the receive antenna radiation pattern in at least one frame during the sensing measurement process the impact of at least one of the transmit power, the receive AGC gain, the transmit antenna radiation pattern, or the receive antenna radiation pattern on the sensing measurement result is eliminated or compensated for, which enables the sensing measurement system to more accurately sense changes in the physical channel, such that the accuracy of the sensing measurement result is improved.

FIG. 12 is a flowchart of a method for sensing measurement according to some embodiments of the present disclosure. The method is illustrated using an example in which the method is performed by a sensing initiator. The method includes at least one of the following processes.

In process 122, at least one frame carrying target information is transmitted and/or received during a sensing measurement process, wherein the target information is related to at least one of a transmit power, a receive AGC gain, a transmit antenna radiation pattern, or a receive antenna radiation pattern.

In some embodiments, the target information is configured to eliminate or compensate for an impact of a change in at least one of the transmit power, the receive AGC gain, the transmit antenna radiation pattern, or the receive antenna radiation pattern on a sensing measurement result.

In some embodiments, transmitting and/or receiving at least one frame carrying the target information during the sensing measurement process includes at least one of:
transmitting a first frame at a sensing measurement setup stage, the first frame carrying the target information;
transmitting a second frame at a sensing measurement stage, the second frame carrying the target information; or
receiving a third frame at a sensing measurement report stage, the third frame carrying the target information.

In some embodiments, the first frame includes a sensing measurement setup request frame.

In some embodiments, the second frame includes a sensing measurement announcement frame or a ranging announcement frame.

In some embodiments, the third frame includes a sensing measurement report request frame or a sensing measurement report response frame.

In some embodiments, the target information is carried in at least one frame transmitted between the PHY layer and the MAC layer for transmission. In some embodiments, the above process includes at least one of:
carrying at least one of the following parameters in a PHY layer configuration vector carried in a PHY layer configuration request primitive transmitted from the MAC layer to the PHY layer:
an AGC constraint parameter; or
a receive antenna radiation pattern constraint parameters; or
carrying an AGC gain parameter in a transmit vector transmitted from the MAC layer to the PHY layer.

In summary, in the method for sensing measurement according to the present embodiments, by carrying target information related to at least one of the transmit power, the receive AGC gain, the transmit antenna radiation pattern, or the receive antenna radiation pattern in at least one frame transmitted and/or received during the sensing measurement process, the impact of at least one of the transmit power, the receive AGC gain, the transmit antenna radiation pattern, or the receive antenna radiation pattern on the sensing measurement result is eliminated or compensated for by the sensing initiator, which enables the sensing measurement system to more accurately sense changes in the physical channel, such that the accuracy of the sensing measurement result is improved.

FIG. 13 is a flowchart of a method for sensing measurement according to some embodiments of the present disclosure. The method is illustrated using an example in which the method is performed by a sensing responder. The method includes at least one of the following processes.

In process 132, at least one frame carrying target information is received and/or transmitted during a sensing measurement process, wherein the target information is related to at least one of a transmit power, a receive AGC gain, a transmit antenna radiation pattern, or a receive antenna radiation pattern.

In some embodiments, the target information is configured to eliminate or compensate for an impact of a change in at least one of the transmit power, the receive AGC gain, the transmit antenna radiation pattern, or the receive antenna radiation pattern on a sensing measurement result.

In some embodiments, transmitting and/or receiving at least one frame carrying the target information during the sensing measurement process includes at least one of:
receiving a first frame at a sensing measurement setup stage, the first frame carrying the target information;
receiving a second frame at a sensing measurement stage, the second frame carrying the target information; or
transmitting a third frame at a sensing measurement report stage, the third frame carrying the target information.

In some embodiments, the first frame includes a sensing measurement setup request frame.

In some embodiments, the second frame includes a sensing measurement announcement frame or a ranging announcement frame.

In some embodiments, the third frame includes a sensing measurement report request frame or a sensing measurement report response frame.

In some embodiments, the target information is carried in at least one frame transmitted between a PHY layer and a MAC layer for transmission. In some embodiments, the above process includes at least one of:
carrying at least one of the following parameters in a PHY layer configuration vector carried in a PHY layer configuration request primitive transmitted from the MAC layer to the PHY layer:
an AGC constraint parameter; or
a receive antenna radiation pattern constraint parameter; or
carrying an AGC gain parameter in a receive vector transmitted from the PHY layer to the MAC layer.

In summary, in the method for sensing measurement according to the present embodiments, by carrying target information related to at least one of the transmit power, the receive AGC gain, the transmit antenna radiation pattern, or the receive antenna radiation pattern in at least one frame received and/or transmitted during the sensing measurement process, the impact of at least one of the transmit power, the receive AGC gain, the transmit antenna radiation pattern, or the receive antenna radiation pattern on the sensing measurement result is eliminated or compensated for by the sensing responder, which enables the sensing measurement system to more accurately sense changes in the physical channel, such that the accuracy of the sensing measurement result is improved.

The present disclosure modifies or newly defines relevant elements and frame formats for the setup stage, the measurement stage, and the report stage of the sensing measurement to transmit relevant information. Several elements and frame formats in the three stages are described hereafter.

### Stage 1: Sensing Measurement Setup Stage

In some embodiments, at least one of the following first fields is carried in at least one frame (such as a first frame) at the sensing measurement setup stage:
a transmit power constraint field, indicating whether to constrain the transmit power for transmitting a measurement frame NDP;
an AGC gain constraint field, indicating whether to constrain the AGC gain for receiving an NDP;
a transmit antenna radiation pattern constraint field, indicating whether to constrain the transmit antenna radiation pattern of the NDP;
a receive antenna radiation pattern constraint field, indicating whether to constrain the receive antenna radiation pattern of the NDP;
a sensing initiator-to-sensing responder (I2R) transmit power Channel State Information (CSI) compensation mode field, indicating a compensation mode in which CSI acquired by I2R measurements is compensated based on a change in the transmit power of the NDP;
a sensing responder-to-sensing initiator (R2I) transmit power CSI compensation mode field, indicating a compensation mode in which CSI acquired by R2I measurements is compensated based on a change in the transmit power of the NDP; or
an AGC gain CSI compensation mode field, indicating a compensation mode in which CSI acquired by I2R measurements is compensated based on a change in the AGC gain.

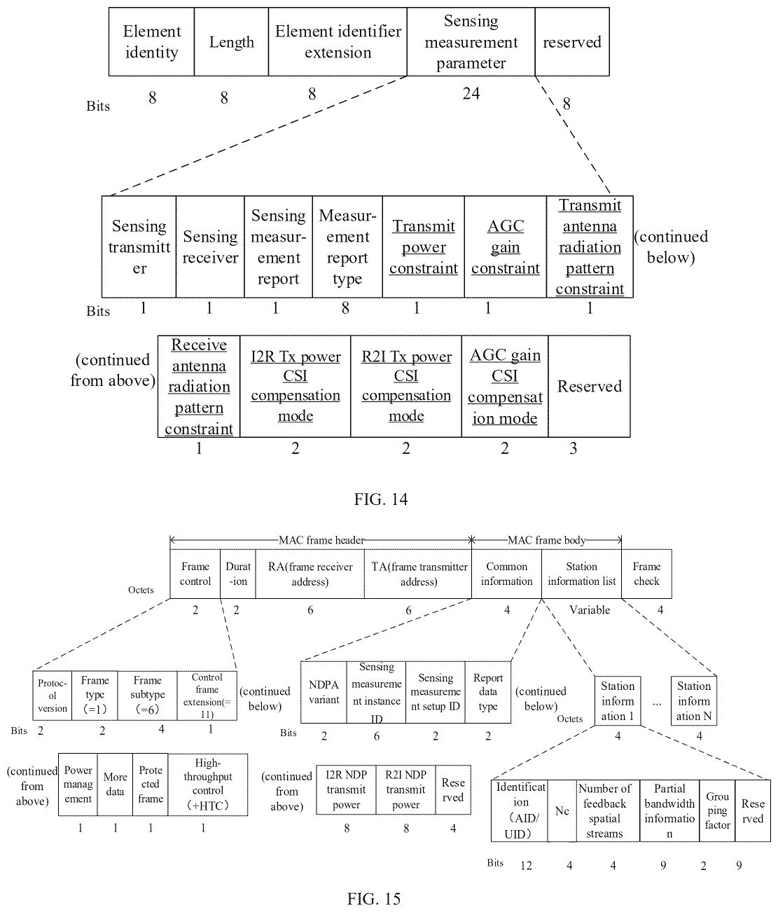

In some embodiments, as shown in FIG. 14, the present disclosure adds a new first field (shown by underlining) to the “sensing measurement parameter” field in the sensing measurement parameter element of the related art, that is, the first field is carried in the sensing measurement parameter element.

The sensing measurement parameter element includes:
an element identity field, indicating that the element is a sensing measurement parameter element, wherein the value of this field is predefined;
a length field, with a value of the number of bytes of the sensing measurement parameter element with the element identity field and the length field removed;
an element identifier extension field, indicating the identifier the extension element;
a reserved field, which is reserved; and
a sensing measurement parameter field, indicating parameters associated with the sensing measurement, including one or more of the following subfields:
   A sensing transmitter subfield: this subfield indicates whether the sensing responder is a sensing transmitter in a sensing measurement instance associated with a sensing measurement setup identity (ID). In some embodiments, “0” indicates that the sensing responder is not a sensing transmitter, and “1” indicates that the sensing responder is a sensing transmitter; or, “0” indicates that the sensing responder is a sensing transmitter, and “1” indicates that the sensing responder is not a sensing transmitter.
   A sensing receiver subfield: this subfield indicates whether the sensing responder is a sensing receiver in a sensing measurement instance associated with a sensing measurement setup ID. In some embodiments, “0” indicates that the sensing responder is not a sensing receiver, and “1” indicates that the sensing responder is a sensing receiver; or, “0” indicates that the sensing responder is a sensing receiver, and “1” indicates that the sensing responder is not a sensing receiver.
   A sensing measurement report subfield: this subfield indicates a reported measurement result in a sensing measurement instance associated with a sensing measurement setup ID. This subfield is reserved in the case that the “sensing receiver” subfield indicates that the sensing responder is not a sensing receiver. In the case that the “sensing receiver” subfield indicates that the sensing responder is a sensing receiver, the sensing measurement report subfield indicates whether the sensing responder transmits a sensing measurement report in a sensing measurement instance. In some embodiments, “0” indicates that the sensing responder does not transmit a sensing measurement report, and “1” indicates that the sensing responder transmits a sensing measurement report; or, “0” indicates that the sensing responder transmits a sensing measurement report, and “1” indicates that the sensing responder does not transmit a sensing measurement report.
   A measurement report type subfield: this subfield is reserved in the case that the “sensing receiver” subfield indicates that the sensing responder is not a sensing receiver. In the case that the “sensing receiver” subfield indicates that the sensing responder is a sensing receiver, the “measurement report type” subfield indicates a type of measurement result reported by the sensing responder in a sensing measurement instance. In some embodiments, values and meanings thereof in the “measurement report type” subfield are as listed in Table 1.

TABLE 1
Values and meanings thereof in the measurement report type subfield

| Value | Meaning |
|---|---|
| 0 | CSI |
| 1-255 | Reserved |

A transmit (Tx) power constraint subfield: this subfield indicates whether the transmit power for an NDP by the sensing transmitter in a sensing measurement instance associated with a sensing measurement setup ID should remain constant or change less than a first threshold. In some embodiments, the first threshold is predefined, pre-configured, configured by a network device/sensing receiver to the sensing transmitter, or determined autonomously by the sensing transmitter. In some embodiments, “0” means no and “1” means Yes; or, “0” means yes and “1” means No.
An AGC gain constraint field: this subfield indicates whether an AGC gain for the NDP reception by the sensing receiver in a sensing measurement instance associated with a sensing measurement setup ID should remain constant or change less than a second threshold. In some embodiments, the second threshold is predefined, pre-configured, configured by a network device/sensing transmitter to the sensing receiver, or determined autonomously by the sensing receiver. In some embodiments, “0” means no and “1” means Yes; or, “0” means yes and “1” means No.
A transmitting (Tx) antenna radiation pattern constraint subfield: this subfield indicates whether a transmit antenna radiation pattern used by the sensing transmitter to transmit the NDP in a sensing measurement instance associated with a sensing measurement setup ID should remain unchanged. In some embodiments, “0” means No and “1” means Yes; or, “0” means Yes and “1” means No.
A receive (Rx) antenna radiation pattern constraint subfield: this subfield indicates whether the receive antenna radiation pattern used by the sensing receiver to receive the NDP in a sensing measurement instance associated with a sensing measurement setup ID should remain unchanged. In some embodiments, “0” means No and “1” means Yes; or, “0” means Yes and “1” means No.
An I2R transmit (Tx) power CSI compensation mode subfield: this subfield is reserved in the case that the “sensing receiver” subfield indicates that the sensing responder is not a sensing receiver. In the case that the “sensing receiver” subfield indicates that the sensing responder is a sensing receiver, the “12R Tx power CSI compensation mode” subfield indicates how to compensate for an impact of a change in NDP transmit power on CSI acquired by I2R measurements in a sensing measurement instance associated with a sensing measurement setup ID.

In some embodiments, a compensation mode indicated by the I2R transmit power CSI compensation mode field includes any of:
no compensation;
the sensing initiator informs the sensing responder device of the transmit power of the NDP, and the sensing responder device compensates for measured CSI based on the transmit power of the NDP; or
the sensing initiator stores the transmit power of the NDP, and compensates for CSI from the sensing responder based on the stored transmit power of the NDP.

In some embodiments, the specific values of the field and meanings thereof are as listed in Table 2.

TABLE 2
Values and their meanings of I2R transmit power CSI compensation mode

| Value | Meaning |
|---|---|
| 0 | No compensation |
| 1 | Sensing responder transmit power |
| | CSI compensation |
| 2 | Sensing initiator transmit power CSI |
| | compensation |
| 3 | Reserved |

### In Table 2:

0 represents no compensation, which indicates that neither the sensing initiator nor the sensing responder performs transmit power CSI compensation.
1 represents sensing responder transmit power CSI compensation, which indicates that the sensing initiator informs the sensing responder of the transmit power for transmitting each NDP, and the sensing responder compensates for CSI calculated by the sensing responder based on the received transmit power.
2 represents sensing initiator transmit power CSI compensation, which indicates that the sensing initiator stores the transmit power for transmitting each NDP in local and compensates for received CSI feedback based on the stored transmit power.
3 represents that the field is reserved.
   An R2I transmit (Tx) power CSI compensation mode subfield: this field is reserved in the case that the “sensing transmitter” subfield indicates that the sensing responder is not a sensing transmitter. In the case that the “sensing transmitter” subfield indicates that the sensing responder is a sensing transmitter, the “R2I Tx power CSI compensation mode” subfield indicates how to compensate for an impact of a change in the NDP transmit power on the CSI acquired by R2I measurements in a sensing measurement instance associated with a sensing measurement setup ID.

In some embodiments, a compensation mode indicated by the R2I transmit power CSI compensation mode field includes any of:
no compensation;
the sensing initiator transmits a specified transmit power for transmitting an NDP by the sensing responder, the sensing responder transmits the NDP based on the specified transmit power, and the sensing initiator compensates for the measured CSI based on the specified transmit power; or
the sensing responder informs the sensing initiator of the transmit power of the NDP, and the sensing initiator compensates for the measured CSI based on the transmit power of the NDP.

In some embodiments, the specific values of the field and meanings thereof are as listed in Table 3.

TABLE 3
Values and their meanings of R2I transmit power CSI compensation mode

| Value | Meaning |
|---|---|
| 0 | No compensation |
| 1 | Compensation by specifying an R2I transmit |
| | power by the sensing initiator |
| 2 | Compensation by feeding back the R2I |
| | transmit power by the sensing responder |
| 3 | Reserved |

### In Table 3:

0 represents no compensation, which indicates that neither the sensing initiator nor the sensing responder performs the R2I transmit power CSI compensation.
1 represents compensation by specifying an R2I transmit power by the sensing initiator, which indicates that the sensing initiator explicitly informs, through a measurement announcement frame (NDP Announcement, NDPA), the sensing responder of the transmit power that should be used for transmitting each NDP, the sensing responder transmits the NDPs based on the transmit power specified by the sensing initiator, and the sensing initiator compensates for CSI calculated by the sensing initiator based on the specified transmit power.

In addition, in the trigger-based sensing measurement setup, the “R2I Tx power CSI compensation mode” field cannot take a value of 1. The reason is that the protocol data unit (i.e., Physical Layer Protocol Data Unit (PPDU)) configured for the NDP in the R2I direction in the trigger-based sensing measurement is a TB PPDU, an uplink transmit power control mechanism is already configured for the transmission of the TB PPDU, and an uplink (UL) target received power field is included in each user information (Info) of a trigger frame, which makes the received power of multiple TB PPDUs received by the sensing receiver (e.g., AP) similar and thus facilitates demodulation by the sensing receiver. Therefore, it is contradictory to specify the transmit power of the sensing transmitter (e.g., STA) on the basis of the existing UL TB PPDU power control.
2 represents compensation by feeding back the R2I transmit power by the sensing responder, which indicates that the sensing responder reports the transmit power for transmitting the NDP to the sensing initiator, and the sensing initiator compensates for the CSI calculated by the sensing initiator based on the received R2I NDP transmit power and reference CSI.
3 represents that the field is reserved.
An AGC gain CSI compensation mode subfield: this field is reserved in the case that the “sense receiver” subfield indicates that the sensing responder is not a sensing receiver. In the case that the “sensing receiver” subfield indicates that the sensing responder is a sensing receiver, the “AGC gain CSI compensation mode” field indicates how to compensate for the impact of a change in the AGC gain of the sensing responder on the CSI acquired by I2R NDP measurements in a sensing measurement instance associated with a sensing measurement setup ID.

In some embodiments, a compensation mode indicated by the AGC gain CSI compensation mode field includes any of:
no compensation;
the sensing responder compensates for measured CSI based on an AGC gain for receiving an NDP; or
the sensing responder transmits the AGC gain for receiving the NDP to the sensing initiator, and the sensing initiator compensates for the measured CSI based on the AGC gain and reference CSI.

In some embodiments, specific values and meanings thereof are as listed in Table 4.

TABLE 4
Values and their meanings of AGC gain CSI compensation mode

| Value | Meaning |
|---|---|
| 0 | No compensation |
| 1 | Sensing responder AGC gain CSI |
| | compensation |
| 2 | Sensing initiator AGC gain CSI |
| | compensation |
| 3 | Reserved |

In Table 4:
0 represents no compensation, which indicates that neither the sensing initiator nor the sensing responder performs AGC gain CSI compensation;
1 represents sensing responder AGC gain CSI compensation, which indicates that the sensing responder compensates for CSI calculated by the sensing responder based on the AGC gain for receiving the NDP by the sensing responder;
2 represents sensing initiator AGC gain CSI compensation, which indicates that the sensing responder returns the AGC gain for receiving the NDP to the sensing initiator via a sensing measurement report frame, and the sensing initiator compensates for received CSI based on the AGC gain and reference CSI; or
3 represents that the field is reserved.

### Stage II: Sensing Measurement Stage

In some embodiments, at least one of the following second fields is carried in at least one frame (such as the second frame) of the sensing measurement stage:
a first I2R NDP transmit power field, indicating a transmit power of an I2R NDP in a sensing measurement instance associated with a sensing measurement instance identity ID; or
a first R2I NDP transmit power field, indicating a transmit power of an R2I NDP in a sensing measurement instance associated with a sensing measurement instance ID.

In some embodiments, at least one of the following frames is included in at least one frame of the sensing measurement stage:
a sensing measurement announcement frame; or
a ranging announcement frame including an identification field, wherein the identification field indicates that the ranging announcement frame is a sensing announcement frame for sensing.

In some embodiments, the present disclosure separately defines, via two methods, the sensing measurement announcement frame (that is, Sensing NDP Announcement Frame) as a newly defined sensing measurement announcement frame and as a sensing measurement announcement frame based on a ranging announcement frame in related art.

### Method I: Newly Defined Sensing Announcement Frame

In some embodiments, as shown in FIG. 15, the present disclosure newly defines a sensing measurement announcement frame (that is, Sensing NDP Announcement Frame), which belongs to the control frame extension subtype. The sensing measurement announcement frame in method I includes at least one portion of a MAC frame header, a MAC frame body, or a frame check field.

The MAC frame header includes at least one field of frame control, duration, frame receiver address (RA), or frame transmitter address (TA); and the MAC frame body includes at least one field of common information or station (STA) information list.

The frame control field includes at least one of the following fields:
a protocol version field, indicating the version of the MAC protocol for the frame, wherein for this field, a value of 0 indicates a MAC frame, a value of 1 indicates a PV1 MAC frame, and other values are reserved;
a frame type field, wherein for this field, a value of 1 indicates that the frame is a control frame;
a frame subtype, where for this field, a value of 6 indicating that the frame is a control frame extension subtype;
a control frame extension field, indicating that the frame is a newly defined sensing measurement announcement frame. The field has a value in the range of [11, 15];
a power management field, indicating the management of the power supply to the sensing measurement device;
a more data field;
a protected management frame field, also referred to as a protected frame field, which is configured to improve the privacy protection of the sensing measurement announcement frame and to ensure the security and stability of the sensing measurements; or
a high-throughput control field, indicating the management of high-speed throughput of sensing measurement data.

The duration field indicates the duration of the sensing measurement.

The RA field indicates the address of the frame receiver.

The TA field indicates the address of the frame transmitter.

The common information field indicates information applicable to all STAs in the station information list, which includes at least one of the following fields.
An NDPA variant field: this field indicates the subtype of the newly defined sensing measurement announcement frame. In some embodiments, the specific values of the field and their meanings are as listed in Table 5.

TABLE 5
Meanings of NDPA variant field

| Value | NDPA variant |
|---|---|
| 0 | Sensing measurement announcement frame variant |
| 1-3 | Reserved |

A sensing measurement instance ID (that is, Measurement Instance ID) field: this field includes an identifier indicating the current sensing measurement instance.
A sensing measurement setup ID (that is, Measurement Setup ID) field: this field includes an identifier indicating the sensing measurement setup associated with the current sensing measurement instance.
A report type field: this field indicates the data type of the sensing measurement result reported by the sensing responder to the sensing initiator. In some embodiments, the values and their meanings of the field are as listed in Table 6. The values in Table 6 are only illustrative, and is possible to be set to other values, as long as the values corresponding to each report data type are different from the values of other report data types.

TABLE 6
Meaning of report data type field

| Value | Report data type |
|---|---|
| 0 | CSI |
| 1-3 | Reserved |

In the case that the report data type is CSI, the sensing responder is instructed to use the CSI report data type defined in 22/0533r3.
An I2R NDP transmit power field, which is also referred to as a first I2R NDP transmit power. In the sensing measurement parameter element of the same sensing measurement setup ID, this field is reserved in the case that the “12R transmit power CSI Compensation Mode” field takes the value of 0, 2, or 3; and in the case that the “12R transmit power CSI compensation mode” field takes the value of 1, then the “I2R NDP transmit power” field indicates the transmit power of the I2R NDP in a sensing measurement instance associated with a sensing measurement instance ID, which is used for the sensing initiator to inform the sensing responder of the transmit power of the I2R NDP, and facilitates the sensing responder completing the transmit power CSI compensation. In some embodiments, the specific values of the field and their meanings are as listed in Table 7.

TABLE 7
Values and meanings of I2R transmit power

| Value | Meaning |
|---|---|
| 0 | −20 dBm |
| 1 | −19 dBm |
| . . . | . . . |
| 59 | 39 dBm |
| 60 | 40 dBm |
| 61~255 | Reserved |

An R2I NDP transmit power field, which is also referred to as a first R2I NDP transmit power. In the sensing measurement parameter element of the same sensing measurement setup ID, this field is reserved in the case that the “R2I transmit power CSI compensation mode” field takes the value 0, 2, or 3; and in the case that the “R2I transmit power CSI compensation mode” field takes the value of 1, then the “R2I NDP transmit power” field indicates the transmit power of the R2I NDP in a sensing measurement instance associated with a sensing measurement instance ID, which is used for the sensing initiator to specify the transmit power of the R2I NDP to be transmitted by the sensing responder, and facilitates the sensing initiator completing the transmit power CSI compensation. In some embodiments, the specific values of the field and their meanings are as listed in Table 8.

TABLE 8
Values and meanings
of R2I transmit power

| Value | Meaning |
|---|---|
| 0 | −20 dBm |
| 1 | −19 dBm |
| . . . | . . . |
| 59 | 39 dBm |
| 60 | 40 dBm |
| 61~255 | Reserved |

Reserved means that the field is reserved.

The station information list includes at least one of station information 1 to station information N (N is an integer greater than or equal to 1). Each station information field includes at least one field of identification, number of columns (Nc), number of feedback spatial streams, partial bandwidth information, grouping factor, or reserved.

In some embodiments, station information 1 is illustrated as an example.
The identification field includes an association identifier (AID) or User Identification (UID), wherein the AID identifies the sensing measurement device that has established an association with the access point.
The Nc field indicates the number of columns of a CSI matrix in a sensing report frame.
The number of feedback spatial streams field indicates the number of spatial streams fed back by the sensing measurement device, with one signal being considered as one spatial stream.
The partial bandwidth information field indicates the Bandwidth Part (BWP) to be reported by the sensing receiver.
The grouping factor field indicates the grouping factor for reporting a measurement result of the data type by the responding device.
The reserved field means that this field is reserved.

### Method II: Sensing Measurement Announcement Frame Based on a Ranging Announcement Frame in the Related Art

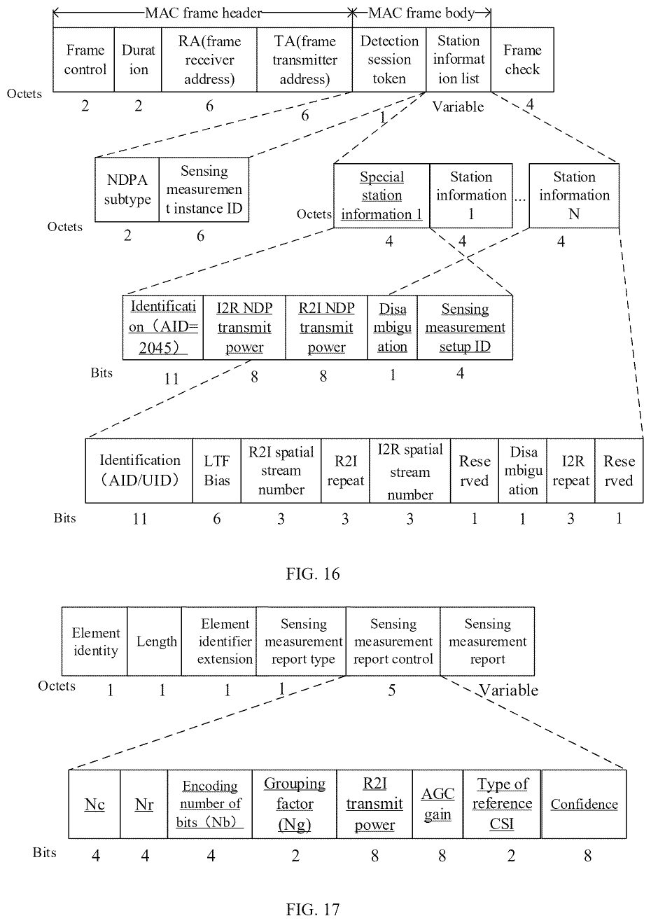

In some embodiments, as shown in FIG. 16, the present disclosure modifies (shown by underlining) the ranging announcement frame in the related art to achieve the same effect as the newly defined sensing measurement announcement frame in method I above. The sensing measurement announcement frame in method II includes at least one portion of a MAC frame header, a MAC frame body, or a frame check field.

The MAC frame header includes at least one field of frame control, duration, RA, or TA; and the MAC frame body includes at least one field of detection session token or station information list.

The frame control field indicates the type of MAC frame.

The duration field indicates the duration of the sensing measurement.

The RA field indicates the address of the frame receiver.

The TA field indicates the address of the frame transmitter.

The detection session token field indicates at least one subtype of the NDPA or the sensing measurement instance ID. The detection session token field includes at least one of the following fields:
an NDPA subtype field, indicating the type of the NDPA; or
a sensing measurement instance ID, which is an identifier indicating the current sensing measurement instance.

The station information list field includes at least one of station information 1 to station information N (N is an integer greater than or equal to 1) and special station information 1.
the special station information includes at least one of the following fields:
an identification field, such as an AID. This field includes an identifier of a station information field, which is configured to identify the station information as special station information for sensing measurements and further identify the ranging announcement frame as a sensing measurement announcement frame. In some embodiments, the field takes the value 2045;
an I2R NDP transmit power field, i.e., the first I2R NDP transmit power field. In the sensing measurement parameter element of the same sensing measurement setup ID, this field is reserved in the case that the “12R transmit power CSI compensation mode” field takes the value of 0, 2, or 3; and in the case that the “12R transmit power CSI compensation mode” field takes the value of 1, the “12R NDP transmit power” field indicates the transmit power of the I2R NDP in a sensing measurement instance associated with a sensing measurement instance ID, which is used for the sensing initiator to inform the sensing responder of the transmit power of the I2R NDP, and facilitates the sensing responder completing the transmit power CSI compensation. In some embodiments, the specific values of the field and their meanings are as listed in Table 7;
an R2I NDP transmit power field, i.e., the first R2I NDP transmit power field. In a sensing measurement parameter element of the same sensing measurement setup ID, this field is reserved in the case that the “R2I transmit power CSI compensation mode” field takes the value of 0, 2, or 3; and in the case that the “R2I transmit power CSI compensation mode” field takes the value of 1, the “R2I NDP transmit power” field indicates the transmit power of the R2I NDP in a sensing measurement instance associated with a sensing measurement instance ID, which is used for the sensing initiator to specify the transmit power of the R2I NDP to be transmitted by the sensing responder, and facilitates the sensing initiator completing the transmit power CSI compensation. In some embodiments, the specific values of the field and their meanings are as listed in Table 8;
a disambiguation field, configured to eliminate parse error for station information fields by legacy devices; or
a sensing measurement setup ID (that is, measurement setup ID) is an identifier of the sensing measurement setup associated with the current sensing measurement instance.

The station information field includes, taking station information N as an example, at least one of the following fields:
an identification field, which includes at least one of an AID or UID, the AID is configured to identify the sensing measurement device that has established an association with the access point;
a long training field (LTF) bias field, which indicates the bias used for secure LTF in the trigger-based sensing measurement;
an R2I spatial stream number field, which indicates the number of spatial streams in the R2I direction;
an R2I repeat field, indicating the number of repeats of the High-Efficiency (HE)-LTF field in the NDP in the R2I direction;
an I2R spatial stream number field, indicating the number of spatial streams in the I2R direction;
a reserved field;
a disambiguation field, configured to eliminate parse error for station information fields by legacy devices;
an I2R repeat field, indicating the number of repeats of the HE-LTF field in the NDP in the I2R direction; or
a reserved field.

### Stage III: Sensing Measurement Report Stage

In some embodiments, at least one of the following third fields is carried in at least one frame (such as, in the third frame) of the sensing measurement report stage:
a second R2I NDP transmit power field, indicating the transmit power of an R2I NDP in a sensing measurement instance associated with a sensing measurement instance identity ID, or a transmit power of an R2I NDP associated with a set of reference channel state information CSI;
an AGC gain field, indicating an AGC gain for receiving an NDP by a sensing responder in a sensing measurement instance associated with a sensing measurement instance ID or an NDP receive AGC gain associated with a set of reference CSI; or
a reference CSI type field, indicating any of measured CSI, reference CSI associated with the R2I transmit power, and reference CSI associated with an AGC gain.

In some embodiments, as shown in FIG. 17, a sensing measurement report element includes at least one field of element identifier, length, element identifier extension, sensing measurement report type, sensing measurement report control, or sensing measurement report. The present disclosure newly defines the sensing measurement report control field in the existing sensing measurement report element.

The element identity field indicates that the element is a sensing measurement report element, wherein a value of the field is predefined.

The length field has a value of the number of bytes of the sensing measurement report element with the element identity field and the length field removed.

The element identifier extension field includes an identifier of an extension element.

The sensing measurement report type field indicates the type of sensing measurement report reported, which includes, in some embodiments, a TB measurement report or a Non-TB measurement report.

The sensing measurement report control field includes at least one of the following subfields (as shown by underline in FIG. 17).
An Nc (Number of Columns) subfield: this subfield indicates the number of columns of the CSI matrix in the sensing report frame. In some embodiments, this field takes a value of the number of columns of a sensing feedback matrix minus one, and values and their meanings of the field are as listed in Table 9.

TABLE 9
Values and their meanings of the Nc field

| | Number of columns of a |
|---|---|
| Value | sensing feedback matrix |
| 0 | 1 |
| 1 | 2 |
| 2 | 3 |
| 3 | 4 |
| . . . | . . . |
| 15 | 16 |

A number of rows (Nr) field: this field indicates the number of rows of the CSI matrix in the sensing report frame. In some embodiments, the field takes the value of the number of rows of the sensing feedback matrix minus one, and values and their meanings of the field are as listed in Table 10.

TABLE 10
Values and their meanings of the Nr field

| | Number of rows of the sensing |
|---|---|
| Value | feedback matrix |
| 0 | 1 |
| 1 | 2 |
| 2 | 3 |
| 3 | 4 |
| . . . | . . . |
| 15 | 16 |

An encoding number of bits (Nb) field: this field indicates the number of data encoding bits for sense the measurement result in the sensing report frame. In some embodiments, the values and their meanings of this field are as listed in Table 11.

TABLE 11
Values and their meanings of
the encoding number of bits field

| Value | Meaning |
|---|---|
| 0 | 8 |
| 1 | 10 |
| 2~15 | Reserved |

The values in Table 11 are only illustrative and are possible to be set to other values as well, as long as the values corresponding to different report data encoding numbers of bits are different from each other.
The grouping factor field: this field indicates the grouping factor used for reporting the measurement result of the data type by the responding device. In some embodiments, the values and their meanings of this field are as listed in Table 12.

TABLE 12
Values and their meanings
of the grouping factor field

| Value | meaning |
|---|---|
| 0 | 4 |
| 1 | 8 |
| 2 | 16 |
| 3-7 | Reserved |

The values in Table 12 are only illustrative and are possible to be set to other values as well, as long as the values corresponding to different grouping factors are different from each other.
An R2I transmit power (R2I Tx power) field: i.e., the second R2I transmit power. In the sensing measurement parameter element of the same sensing measurement setup ID, this field is reserved in the case that the “R2I transmit power CSI compensation mode” field takes the value of 0, 1, or 3; and in the case that the “R2I transmit power CSI compensation mode” field takes the value of 2, then the “R2I Tx power” field indicates the transmit power of an R2I NDP in a sensing measurement instance associated with a sensing measurement instance ID or the transmit power of an R2I NDP associated with a set of reference CSI. In some embodiments, the values and their meanings of the field are as listed in Table 13.

TABLE 13
Values and their meanings
of the transmit power field

| Value | Meaning |
|---|---|
| 0 | −20 dBm |
| 1 | −19 dBm |
| . . . | . . . |
| 59 | 39 dBm |
| 60 | 40 dBm |
| 61~255 | Reserved |

An AGC gain level field: in the sensing measurement parameter element of the same sensing measurement setup ID, this field is reserved in the case that the “AGC gain CSI compensation mode” field takes the value of 0, 1, or 3; and in the case that the “AGC gain CSI compensation mode” field takes the value of 2, the “AGC gain level” field indicates an AGC gain for receiving an NDP by the sensing responder in a sensing measurement instance associated with a sensing measurement instance ID or an AGC gain associated with a set of reference CSI. In some embodiments, the values and their meanings of the field are as listed in Table 14.

TABLE 14
Values and their meanings
of the AGC gain field

| Value | Meaning |
|---|---|
| 0 | −20 dB |
| 1 | −19 dB |
| . . . | . . . |
| 79 | 59 dB |
| 80 | 60 dB |
| 81~255 | Reserved |

A field of type of reference CSI: in the sensing measurement parameter element of the same sensing measurement setup ID, this field is reserved in the case that the value of the “R2I transmit power CSI compensation mode” field is 0, 1, or 3 and the value of the “AGC gain CSI compensation mode” field is 0, 1, or 3; otherwise, in some embodiments, the values and their meanings of this field are as listed in Table 15.

TABLE 15
Values and their meanings of the
field of type of reference CSI

| Value | Meaning |
|---|---|
| 0 | Measured CSI |
| 1 | Reference CSI associated |
| | with an R2I transmit power |
| 2 | Reference CSI associated |
| | with an AGC gain |
| 3 | Reserved |

### In Table 15:

0 represents measured CSI, which indicates that the data carried in the “sensing measurement report” field of the sensing measurement report element is CSI data measured in real-time, i.e., CSI data measured based on NDP in a sensing measurement instance associated with a sensing measurement instance ID.
1 represents reference CSI associated with an R2I transmit power, which indicates that the data carried in the “sensing measurement report” field of the sensing measurement report element is a set of reference CSI data used by the sensing initiator to implement R2I transmit power CSI compensation. The reference CSI is related to the transmit power for transmitting the R2I NDP by the sensing responder, and one set of reference CSI data corresponds to a transmit power level (indicated by the “R2I transmit power” field). The reference CSI is fixed data pre-stored in a local cache by the sensing responder, rather than real-time measured CSI data.
2 represents reference CSI associated with an AGC gain, which indicates that data carried in the “sensing measurement report” field in the sensing measurement report element is a set of reference CSI data used by the sensing initiator to implement AGC gain CSI compensation. The reference CSI is related to the AGC gain level used by the sensing responder to receive the I2R NDP, and one set of reference CSI data corresponds to one AGC gain level (indicated by the “AGC gain” field). The reference CSI is fixed data pre-stored in the local cache by the sensing responder, rather than real-time measured CSI data.
3 represents that the field is reserved.

It should be understood that the encoding formats for the reference CSI data and the real-time CSI data are the same, with the only difference being that the real-time CSI data is the result data of a real sensing measurement, whereas the reference CSI data is the reference data pre-configured by the sensing responder. The purpose is only to inform the sensing initiator of the nonlinear frequency response characteristics of the R2I NDP transmit power to CSI and the nonlinear frequency response characteristics of the AGC to CSI in the sensing responder, thereby facilitating the sensing initiator completing the R2I transmit power CSI compensation and the AGC gain CSI compensation separately.

In the case that the “type of reference CSI” field takes a value of 1 or 2, among multiple sensing measurement instances associated with the same sensing measurement setup ID, the sensing measurement report elements in the sensing measurement report frames of the first several sensing measurement instances carry only the reference CSI data, i.e., the “type of reference CSI” field in the sensing measurement report element takes a value of 1 or 2. The exact number of sensing measurement instances depends on the reference CSI data volume pre-configured by the sensing responder, and is related to implementations. In the case that the reference CSI data transmission is finished, the next sensing measurement instance starts to carry the CSI data acquired by real measurements in the current sensing measurement instance, i.e., the “type of reference CSI” field in the sensing measurement report element takes the value of 0.
A confidence field: this field indicates the confidence that the sensing receiver determines the result of the current sensing measurement as an accurate measurement result, which is used to assist the sensing initiator in evaluating and/or processing the result of the current sensing measurement. In some embodiments, the result of the present sensing measurement is a relevant parameter of the CSI, or other parameters indicating channel characteristics or channel quality.

Taking that the result of the current sensing measurement is the relevant parameter of the CSI as an example, because the assessment of the confidence of the CSI measurement result is generally performed by a device that generates the CSI parameter (e.g., sensing receiver, etc.), in the case that a device that receives the CSI measurement result (e.g., sensing initiator) uses the CSI measurement result to transmit data without knowing the accuracy or confidence of the CSI measurement result, the data transmission is likely to be negatively affected. Therefore, the confidence field facilitates the device receiving the current sensing measurement result (e.g., sensing initiator) to be informed of the accuracy or confidence of the current sensing measurement result, thereby facilitating the subsequent sensing measurement process or other data transmission.

Methods for estimating confidence are related to implementations. Various formats are available for the field.

In some embodiments, the format of the field includes at least one of a signed integer or an unsigned integer. In some embodiments, a plurality of bits occupied by the field form a plurality of code points, the plurality of code points including a first portion of code points and a second portion of code points, wherein each code point in the first portion of code points indicates a value of the confidence, and the second portion of code points indicates whether the value of the confidence is present and/or reserved. In other embodiments, the plurality of bits occupied by the field include a first portion of bits and a second portion of bits, the code point formed by the first portion of bits indicates the value of the confidence, and the second portion of bits indicates whether the value of the confidence is present, which is not limited in the embodiments of the present disclosure.

In some embodiments, the field includes an 8-bit binary unsigned integer, with different values representing different confidence. Larger values represent greater confidence. A range of valid values for the field is large or small. One embodiment is shown in Table 16.

TABLE 16
Values and their meanings
of confidence field

| Value | Meaning |
|---|---|
| 0 | 0% Confidence |
| 1 | 1% Confidence |
| 2 | 2% Confidence |
| . . . | . . . |
| 99 | 99% Confidence |
| 100 | 100% Confidence |
| 101 | Reserved |
| 102 | Reserved |
| . . . | . . . |
| 254 | Reserved |
| 255 | Confidence not existing |

In the above embodiments, the valid values range from 0 to 100, representing 0% to 100% confidence.

In other embodiments, the valid values range from 0 to 254, representing 0% to 254% confidence.

In some embodiments, the field includes a complement of an 8-bit binary signed integer, with different values representing different confidence. Larger values represent greater confidence. The range of valid values for the field is large or small. One embodiment is shown in Table 17.

TABLE 17
Values and their meanings of confidence field

| Value | Meaning |
|---|---|
| −128 | Confidence not existing |
| −127 | −127% Confidence |
| . . . | . . . |
| −2 | −2% Confidence |
| −1 | −1% Confidence |
| 0 | 0% Confidence |
| 1 | 1% Confidence |
| 2 | 2% Confidence |
| . . . | . . . |
| 126 | 126% Confidence |
| 127 | 127% Confidence |

In the above embodiment, the valid values range from −127 to 127, representing −127% to 127% confidence, wherein for this field, a value of −128 indicates that the confidence does not exist.

In other embodiments, the valid values range from −100 to 100, representing −100% to 100% confidence, wherein for this field, a value of −128 indicates that the confidence does not exist and other values indicate that the field is reserved.

In some embodiments, the field is a complement of an 8-bit binary signed integer, and the following formula shows the meaning of the value of the field:

$$40 \times {log}_{10} \frac{Probability of the measurement result being accurate}{Probability of the measurement result being inaccurate} .$$

Different values represent different confidence, with larger values representing greater confidence, and the range of valid values for this field is large or small. One embodiment of the field is shown in Table 18.

TABLE 18
Values and their meanings of the confidence field

| Value | Meaning | |
|---|---|---|
| −128 | Confidence not existing | |
| −127 | −31.75 | dB Confidence |
| −126 | −31.5 | dB Confidence |
| . . . | . . . | |
| −2 | −0.5 | dB Confidence |
| −1 | −0.25 | dB Confidence |
| 0 | 0 | dB Confidence |
| 1 | 0.25 | dB Confidence |
| 2 | 0.5 | dB Confidence |
| . . . | . . . | |
| 126 | 31.5 | dB Confidence |
| 127 | 31.75 | dB Confidence |

In the above embodiment, valid values range from −127 to 127, representing confidence of −31.75 dB to 31.75 dB, wherein for this field, a value of −128 indicates that the confidence does not exist.

In other embodiments, the valid values range from −100 to 100, representing −31.75 dB to 31.75 dB confidence, wherein for this field, a value of −128 indicates that the confidence does not exist, and other values indicate that the field is reserved.

In some embodiments, the field includes a 2-byte 16-bit binary unsigned integer, or a complement of a 2-byte 16-bit binary signed integer, and the meanings and patterns of the values are similar to Table 16, Table 17, or Table 18.

In some embodiments, the existence or nonexistence of the confidence field is indicated by an unused portion of values of the confidence field, by a byte independent of the confidence field, or by a bit independent of the confidence field.

The values and meanings of the confidence field described above are merely schematic illustrations and are not limited in the present disclosure.

The numbers below the field shown in FIG. 14 to 17 described above represent the number of bits or bytes (Octets) of the field.

In the present disclosure, the method for sensing measurement is categorized into at least three types according to the compensation mode, namely:
type I: I2R transmit power CSI compensation;
type II: R2I transmit power CSI compensation; and
type III: AGC gain CSI compensation.
   Type I: I2R Transmit Power CSI Compensation, Illustrated with an Example of Non-Trigger-Based Sensing Measurement

### Mode I: No Compensation

In the embodiments, both the sensing initiator and the sensing responder are a sensing transmitter and a sensing receiver simultaneously, i.e., both the two devices are capable of transmitting and receiving an NDP.

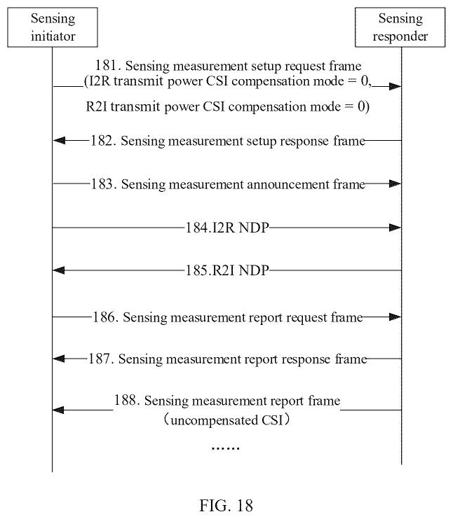

FIG. 18 is a flowchart of a method for sensing measurement according to some embodiments of the present disclosure, the method including at least some of the following processes.

In process 181, the sensing initiator transmits a sensing measurement setup request frame to the sensing responder;

wherein the I2R transmit power CSI compensation mode field has a value of 0, and the R2I transmit power CSI compensation mode field has a value of 0, indicating that no transmit power CSI compensation is required for the sensing measurements of both I2R and R2I.

In process 182, the sensing responder transmits a sensing measurement setup response frame to the sensing initiator.

In process 183, the sensing initiator transmits a sensing measurement announcement frame to the sensing responder.

In process 184, the sensing initiator transmits an I2R NDP to the sensing responder.

In process 185, the sensing responder transmits an R2I NDP to the sensing initiator.

In process 186, the sensing initiator transmits a sensing measurement report request frame to the sensing responder.

In process 187, the sensing responder transmits a sensing measurement report response frame to the sensing initiator.

In process 188, the sensing responder transmits a sensing measurement report frame to the sensing initiator. The CSI reported in the sensing measurement report frame is uncompensated CSI.

In the method according to the embodiments, in the case that the channel state of the sensing measurement system is good, it is indicated by the “I2R transmit power CSI compensation mode” field that no compensation is needed for I2R transmit power CSI, which ensures the accuracy of the sensing measurement results and avoids the resource waste caused by performing CSI compensation.

### Mode II: Sensing Responder Transmit Power CSI Compensation

Both the sensing initiator and the sensing responder in the embodiment are a sensing transmitter and a sensing receiver simultaneously, i.e., both the two devices are capable of transmitting and receiving an NDP.

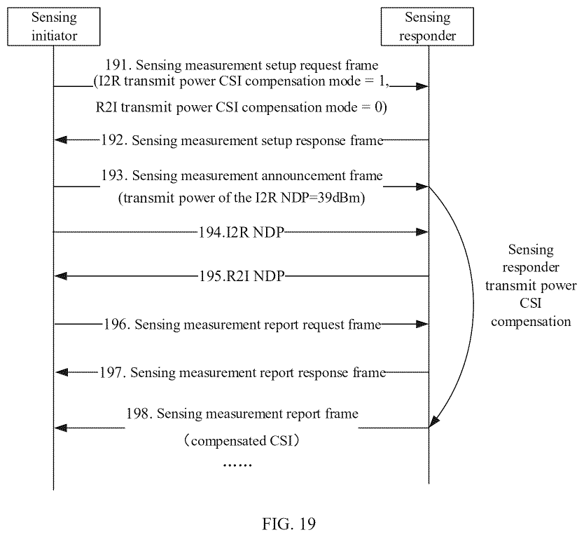

FIG. 19 is a flowchart of a method for sensing measurement according to some embodiments of the present disclosure. The method included at least some of the following processes.

In process 191, the sensing initiator transmits a sensing measurement setup request frame to the sensing responder,
wherein the I2R transmit power CSI compensation mode field has a value of 1 and the R2I transmit power CSI compensation mode filed has a value of 0, indicating that the “sensing responder transmit power CSI compensation” is necessary for the sensing measurement result of I2R, and the sensing measurement result of R2I needs no compensation.

In process 192, the sensing responder transmits a sensing measurement setup response frame to the sensing initiator.

In process 193, the sensing initiator transmits a sensing measurement announcement frame to the sensing responder.

The sensing initiator (the sensing transmitter of I2R) transmits a sensing measurement announcement frame to the sensing responder (the sensing receiver of I2R) indicating the transmit power of the I2R NDP for each sensing measurement instance. In some embodiments, the transmit power of the I2R NDP is 39 dBm.

In process 194, the sensing initiator transmits the I2R NDP to the sensing responder.

The sensing responder compensates for the CSI result based on a degree of change in the transmit power of the I2R NDP.

In process 195, the sensing responder transmits the R2I NDP to the sensing initiator.

In process 196, the sensing initiator transmits a sensing measurement report request frame to the sensing responder.

In process 197, the sensing responder transmits a sensing measurement report response frame to the sensing initiator.

In process 198, the sensing responder transmits a sensing measurement report frame to the sensing initiator. The CSI reported in the sensing measurement report frame is a CSI upon compensation by the sensing responder.

In the method according to the embodiments, in the case that the sensing measurement channel in the I2R direction is subject to path loss or is weak, and the sensing responder has a better communication condition than the sensing initiator or the sensing initiator is unable to compensate for the CSI, the sensing responder is instructed to perform the I2R transmit power CSI compensation through the “12R transmit power CSI compensation mode” field, which improves the accuracy of the sensing measurement results and ensures the normal operation of the sensing measurement system.

### Mode III: Sensing Initiator Transmit Power CSI Compensation

Both the sensing initiator and the sensing responder in this embodiment are a sensing transmitter and a sensing receiver simultaneously, i.e., both the two devices are capable of transmitting and receiving an NDP.

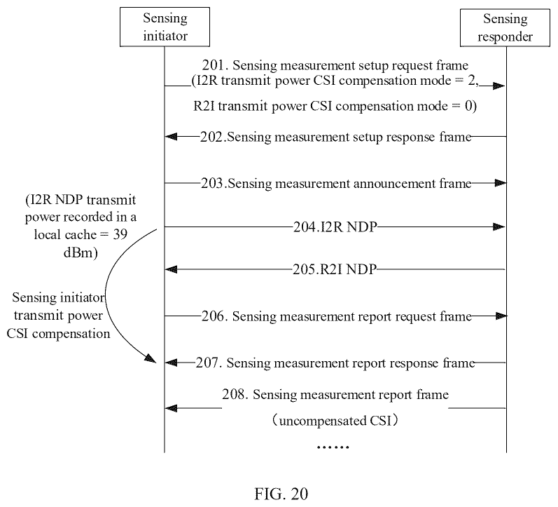

FIG. 20 is a flowchart of a method for sensing measurement according to some embodiments of the present disclosure. The method includes at least some of the following processes.

In process 201, the sensing initiator transmits a sensing measurement setup request frame to the sensing responder,
wherein the I2R transmit power CSI compensation mode field has a value of 2 and the R2I transmit power CSI compensation mode field has a value of 0, indicating that the “sensing initiator transmit power CSI compensation” is necessary for the sensing measurement result of I2R, and the sensing measurement result of R2I needs no compensation.

In process 202, the sensing responder transmits a sensing measurement setup response frame to the sensing initiator.

In process 203, the sensing initiator transmits a sensing measurement announcement frame to the sensing responder.

In process 204, the sensing initiator transmits an I2R NDP to the sensing responder.

The sensing initiator (the sensing transmitter of I2R) records, in a local cache, the transmit power of the I2R NDP for each sensing measurement instance. In some embodiments, the transmit power of the I2R NDP is 39 dBm.

In process 205, the sensing responder transmits the R2I NDP to the sensing initiator.

In process 206, the sensing initiator transmits a sensing measurement report request frame to the sensing responder.

In process 207, the sensing responder transmits a sensing measurement report response frame to the sensing initiator.

In process 208, the sensing responder transmits a sensing measurement report frame to the sensing initiator. The CSI reported in the sensing measurement report frame is uncompensated CSI. Upon receiving the sensing measurement report frame and uncompensated CSI from the sensing responder, the sensing initiator compensates for the CSI based on a degree of change in the I2R NDP transmit power that has been cached.

In the method according to the embodiments, in the case that the sensing measurement channel in the I2R direction is subject to path loss or is weak, and the sensing initiator has a better communication condition than the sensing responder or the sensing responder is unable to compensate for the CSI, the sensing initiator is instructed to perform the I2R transmit power CSI compensation through the “I2R transmit power CSI compensation mode” field, which improves the accuracy of the sensing measurement results and ensures the normal operation of the sensing measurement system.

In summary, type I in the present disclosure provides three I2R transmit power CSI compensation modes, and by introducing the “I2R transmit power CSI compensation mode” field, the I2R transmit power CSI is flexibly compensated in different scenarios, which eliminates the impacts of changes in the NDP transmit power on the CSI acquired by I2R measurements, and improves the accuracy of the sensing measurement results.

### Type II: R2I Transmit Power CSI Compensation, Illustrated by an Example of Non-Trigger-Based Sensing Measurement

### Mode I: No Compensation

Both the sensing initiator and sensing responder in this embodiment are a sensing transmitter and sensing receiver simultaneously, i.e., both the two devices are capable of transmitting and receiving an NDP.

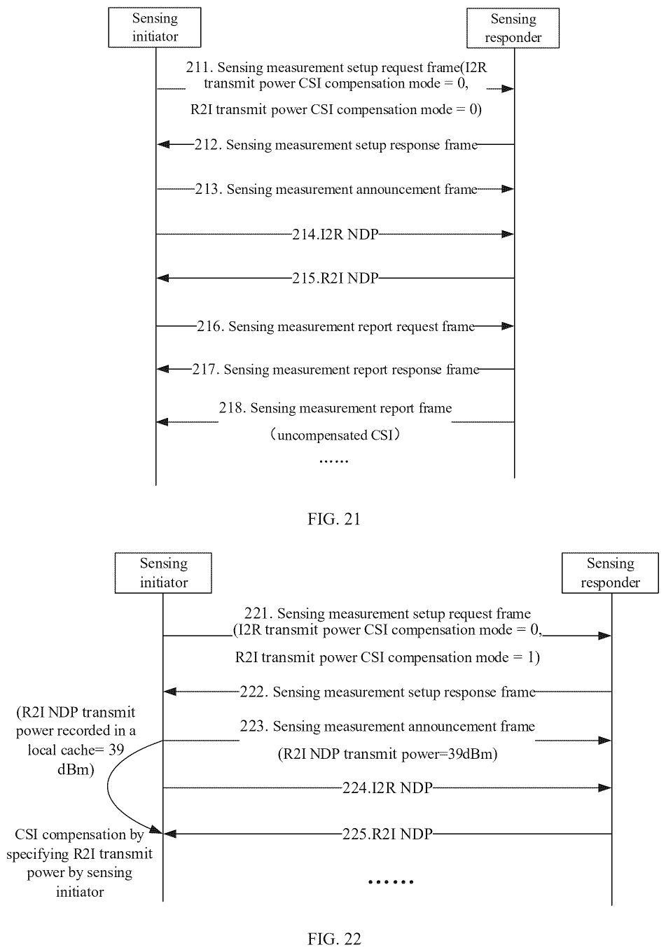

FIG. 21 is a flowchart of a method for sensing measurement according to some embodiments of the present disclosure. The method includes at least some of the following processes.

In process 211, the sensing initiator transmits a sensing measurement setup request frame to the sensing responder,
wherein the I2R transmit power CSI compensation mode field has a value of 0, and the R2I transmit power CSI compensation mode field has a value of 0, indicating that no transmit power CSI compensation is needed for the sensing measurement results of both I2R and R2I.

In process 212, the sensing responder transmits a sensing measurement setup response frame to the sensing initiator.

In process 213, the sensing initiator transmits a sensing measurement announcement frame to the sensing responder.

In process 214, the sensing initiator transmits an I2R NDP to the sensing responder.

In process 215, the sensing responder transmits an R2I NDP to the sensing initiator.

In process 216, the sensing initiator transmits a sensing measurement report request frame to the sensing responder.

In process 217, the sensing responder transmits a sensing measurement report response frame to the sensing initiator.

In process 218, the sensing responder transmits a sensing measurement report frame to the sensing initiator. The CSI reported in the sensing measurement report frame is an uncompensated CSI.

In the method according to the embodiments, in the case that the channel state of the sensing measurement system is good, it is indicated by the “I2R transmit power CSI compensation mode” field that no compensation is needed for I2R transmit power CSI, which ensures the accuracy of the sensing measurement results and avoids the resource waste caused by performing CSI compensation.

### Mode II: CSI Compensation by Specifying an R2I Transmit Power by Sensing Initiator

Both the sensing initiator and the sensing responder in the embodiments are a sensing transmitter and a sensing receiver simultaneously, i.e., both two devices are capable of transmitting and receiving an NDP.

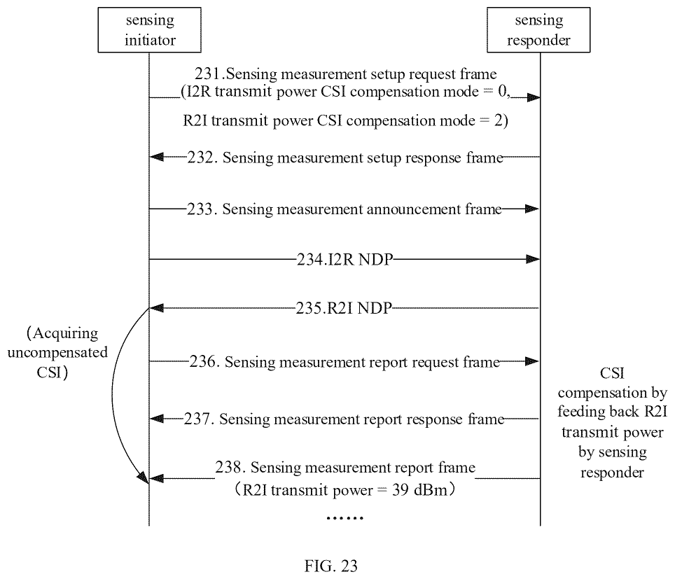

FIG. 22 is a flowchart of a method for sensing measurement according to some embodiments of the present disclosure. The method includes at least some of the following processes.

In process 221, the sensing initiator transmits a sensing measurement setup request frame to the sensing responder,

wherein the I2R transmit power CSI compensation mode field has a value of 0, and the R2I transmit power CSI compensation mode field has a value of 1, indicating that the I2R sensing measurement result needs no transmit power CSI compensation, and the “CSI compensation by specifying an R2I transmit power by sensing initiator” is necessary for the R2I sensing measurement result.

In process 222, the sensing responder transmits a sensing measurement setup response frame to the sensing initiator.

In process 223, the sensing initiator transmits a sensing measurement announcement frame to the sensing responder.

The sensing initiator specifies, in each sensing measurement instance, a transmit power of the R2I NDP through the sensing measurement announcement frame, and records the value of the transmit power of the R2I NDP in a local cache. In some embodiments, the transmit power of the R2I NDP is 39 dBm.

In process 224, the sensing initiator transmits the I2R NDP to the sensing responder.

In process 225, the sensing responder transmits the R2I NDP to the sensing initiator.

The sensing responder transmits the R2I NDP to the sensing initiator in accordance with the transmit power value of the R2I NDP specified by the sensing initiator in the sensing measurement announcement frame. The sensing receiver receives and acquires the CSI measurement result. Upon comparing with the R2I NDP transmit power recorded in the local cache, the sensing initiator compensates for the CSI based on a degree of change in the R2I NDP transmit power.

In the method according to the embodiments, in the case that the sensing measurement channel in the R2I direction is subject to path loss or is weak, and the sensing initiator has a better communication condition than the sensing responder or the sensing responder is unable to compensate for the CSI, the sensing initiator is instructed to perform the R2I transmit power CSI compensation through the “R2I transmit power CSI compensation mode” field, which improves the accuracy of the sensing measurement results and ensures the normal operation of the sensing measurement system.

### Mode III: CSI Compensation by Feeding Back an R2I Transmit Power by Sensing Responder

Both the sensing initiator and the sensing responder in this embodiment are a sensing transmitter and a sensing receiver simultaneously, i.e., both two devices are capable of transmitting and receiving an NDP.

FIG. 23 is a flowchart of a method for sensing measurement according to some embodiments of the present disclosure. The method includes at least some of the following processes.

In process 231, the sensing initiator transmits a sensing measurement setup request frame to the sensing responder,
wherein the I2R transmit power CSI compensation mode field has a value of 0, and the R2I transmit power CSI compensation mode field has a value of 2, indicating that the sensing measurement result of I2R needs no compensation, and the “CSI compensation by feeding back an R2I transmit power by sensing responder” is necessary for the sensing measurement result of R2I.

In process 232, the sensing responder transmits a sensing measurement setup response frame to the sensing initiator.

In process 233, the sensing initiator transmits a sensing measurement announcement frame to the sensing responder.

In process 234, the sensing initiator transmits an I2R NDP to the sensing responder.

In process 235, the sensing responder transmits an R2I NDP to the sensing initiator.

The sensing initiator receives the R2I NDP and calculates the uncompensated CSI.

In process 236, the sensing initiator transmits a sensing measurement report request frame to the sensing responder.

In process 237, the sensing responder transmits a sensing measurement report response frame to the sensing initiator.

In process 238, the sensing responder transmits a sensing measurement report frame to the sensing initiator. The sensing measurement report frame includes the transmit power of the R2I NDP. In some embodiments, the transmit power of the R2I NDP is 39 dBm.

The sensing initiator compares the transmit power of the received R2I NDP with the R2I NDP fed back by the sensing responder, and then compensates for the CSI calculated by the sensing initiator based on the degree of change in the R2I NDP transmit power.

In the method according to the embodiments, in the case that the sensing measurement channel in the R2I direction is subject to path loss or is weak, and the sensing responder has a better communication condition than the sensing initiator or the sensing initiator is unable to compensate for the CSI, the sensing responder is instructed, by the “R2I transmit power CSI compensation mode” field, to feed back an R2I transmit power so as to achieve the CSI compensation, which improves the accuracy of the sensing measurement results and ensures the normal operation of the sensing measurement system. In summary, type II in the present disclosure provides three R2I transmit power CSI compensation modes, and by introducing the “R2I transmit power CSI compensation mode” field, the R2I transmit power CSI is flexibly compensated in different scenarios, which eliminates the impacts of changes in the NDP transmit power on the CSI acquired by R2I measurements, and improves the accuracy of the sensing measurement results.

### Type III: AGC Gain CSI Compensation, Illustrated by an Example of Non-Trigger-Based Sensing Measurement

Because the impact of the change in AGC gain of an R2I NDP on CSI and compensation thereof is an implementation issue within the sensing initiator and is not related to the communication protocol, only the impact of AGC gain CSI compensation of the I2R NDP on the sensing measurement result is considered.

### Mode I: No Compensation

Both the sensing initiator and sensing responder in this embodiment are a sensing transmitter and a sensing receiver simultaneously, i.e., both the two devices are capable of transmitting and receiving an NDP.

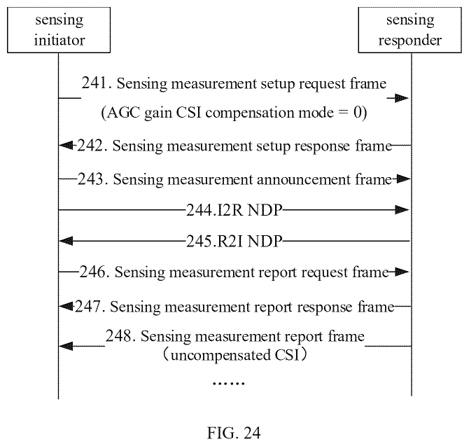

FIG. 24 is a flowchart of a method for sensing measurement according to some embodiments of the present disclosure. The method includes at least some of the following processes.

In process 241, the sensing initiator transmits a sensing measurement setup request frame to the sensing responder,
wherein the AGC gain CSI compensation mode field has a value of 0, indicating that the sensing measurement result of the I2R NDP needs no AGC gain CSI compensation.

In process 242, the sensing responder transmits a sensing measurement setup response frame to the sensing initiator.

In process 243, the sensing initiator transmits a sensing measurement announcement frame to the sensing responder.

In process 244, the sensing initiator transmits an I2R NDP to the sensing responder.

In process 245, the sensing responder transmits an R2I NDP to the sensing initiator.

In process 246, the sensing initiator transmits a sensing measurement report request frame to the sensing responder.

In process 247, the sensing responder transmits a sensing measurement report response frame to the sensing initiator.

In process 248, the sensing responder transmits a sensing measurement report frame to the sensing initiator. The CSI reported in the sensing measurement report frame is uncompensated CSI.

In the method according to the embodiments, in the case that the channel state of the sensing measurement system is good, it is indicated by the “AGC gain CSI compensation mode” field that no AGC gain CSI compensation is needed, which ensures the accuracy of the sensing measurement results and avoids the resource waste caused by performing CSI compensation.

### Mode II: Sensing Responder AGC Gain CSI Compensation

Both the sensing initiator and the sensing responder in this embodiment are a sensing transmitter and a sensing receiver simultaneously, i.e., both the two devices are capable of transmitting and receiving an NDP.

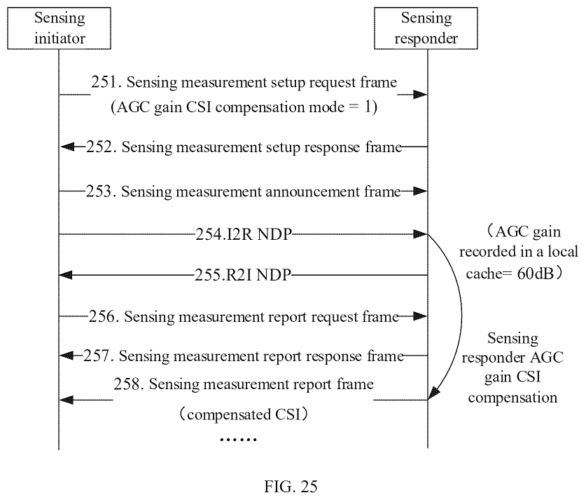

FIG. 25 is a flowchart of a method for sensing measurement according to some embodiments of the present disclosure. The method includes at least some of the following processes.

In process 251, the sensing initiator transmits a sensing measurement setup request frame to the sensing responder,
wherein the AGC gain CSI compensation mode field has a value of 1, indicating that “sensing responder AGC gain CSI compensation” is necessary for the sensing measurement result of the I2R NDP.

In process 252, the sensing responder transmits a sensing measurement setup response frame to the sensing initiator.

In process 253, the sensing initiator transmits a sensing measurement announcement frame to the sensing responder.

In process 254, the sensing initiator transmits an I2R NDP to the sensing responder.

In each sensing measurement instance, the sensing responder records, in a local cache, a gain value of the AGC for receiving the I2R NDP. In some embodiments, the AGC gain value is 60 dB. The sensing responder performs CSI compensation based on a degree of change in the AGC gain.

In process 255, the sensing responder transmits the R2I NDP to the sensing initiator.

In process 256, the sensing initiator transmits a sensing measurement report request frame to the sensing responder.

In process 257, the sensing responder transmits a sensing measurement report response frame to the sensing initiator.

In process 258, the sensing responder transmits a sensing measurement report frame to the sensing initiator. The CSI reported in the sensing measurement report frame is the compensated CSI by the sensing responder.

In the method according to the embodiments, in the case that the sensing measurement channel in the I2R direction is subject to path loss or is weak, and the sensing responder has a better communication condition than the sensing initiator or the sensing initiator is unable to compensate for the CSI, it is indicated by the “AGC gain CSI compensation mode” field that the sensing responder AGC gain CSI compensation is to be performed, which improves the accuracy of the sensing measurement results and ensures the normal operation of the sensing measurement system.

### Mode III: Sensing Initiator AGC Gain CSI Compensation

Both the sensing initiator and the sensing responder in this embodiment are a sensing transmitter and a sensing receiver simultaneously, i.e., both the two devices are capable of transmitting and receiving an NDP.

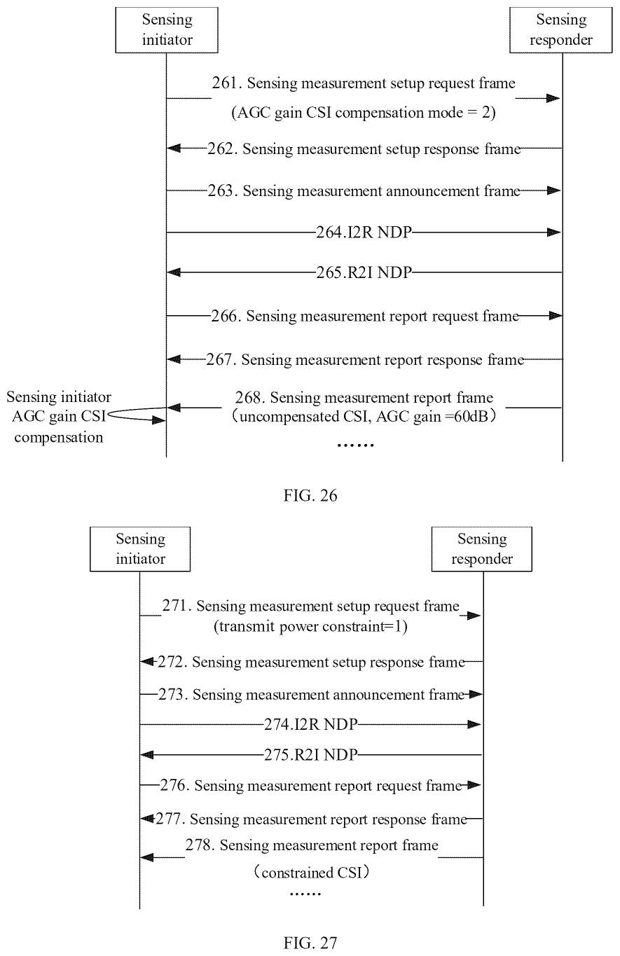

FIG. 26 is a flowchart of a method for sensing measurement according to some embodiments of the present disclosure. The method includes at least some of the following processes.

In process 261, the sensing initiator transmits a sensing measurement setup request frame to the sensing responder,
wherein the AGC gain CSI compensation mode field has a value of 2, indicating that “sensing initiator AGC gain CSI compensation” is necessary for the sensing measurement result of the I2R NDP.

In process 262, the sensing responder transmits a sensing measurement setup response frame to the sensing initiator.

In process 263, the sensing initiator transmits a sensing measurement announcement frame to the sensing responder.

In process 264, the sensing initiator transmits an I2R NDP to the sensing responder.

In process 265, the sensing responder transmits an R2I NDP to the sensing initiator.

In process 266, the sensing initiator transmits a sensing measurement report request frame to the sensing responder.

In process 267, the sensing responder transmits a sensing measurement report response frame to the sensing initiator.

In process 268, the sensing responder transmits a sensing measurement report frame to the sensing initiator. The sensing measurement report frame includes the uncompensated CSI and the AGC gain value for receiving the I2R NDP by the sensing responder. In some embodiments, the AGC gain value for receiving the I2R NDP by the sensing responder is 60 dB.

The sensing initiator compensates for the received uncompensated CSI based on a degree of change in the AGC gain.

In the method according to the embodiments, in the case that the sensing measurement channel in the I2R direction is subject to path loss or is weak, and the sensing initiator has a better communication condition than the sensing responder or the sensing responder is unable to compensate for the CSI, it is indicated by the “AGC gain CSI compensation mode” field that the sensing initiator AGC gain CSI compensation is to be performed, which improves the accuracy of the sensing measurement results and ensures the normal operation of the sensing measurement system.

In summary, type III in the present disclosure provides three AGC gain CSI compensation modes, and by introducing the “AGC gain CSI compensation mode” field, the CSI is flexibly compensated in different scenarios, which eliminates the impacts of changes in AGC gain on the CSI acquired by I2R NDP measurements, and improves the accuracy of the sensing measurement results.

FIG. 27 is a flowchart of a method for sensing measurement according to some embodiments of the present disclosure. The embodiment is illustrated using an example in which a transmit power constraint is used in non-trigger-based sensing measurements. The method includes at least some of the following processes.

In process 271, a sensing initiator transmits a sensing measurement setup request frame to a sensing responder.

In process 272, the sensing responder transmits a sensing measurement setup response frame to the sensing initiator.

In process 273, the sensing initiator transmits a sensing measurement announcement frame to the sensing responder.

In process 274, the sensing initiator transmits an I2R NDP to the sensing responder.

In process 275, the sensing responder transmits an R2I NDP to the sensing initiator.

In process 276, the sensing initiator transmits a sensing measurement report request frame to the sensing responder.

In process 277, the sensing responder transmits a sensing measurement report response frame to the sensing initiator.

In process 278, the sensing responder transmits a sensing measurement report frame to the sensing initiator.

The sensing measurement setup request frame or the sensing measurement announcement frame includes a transmit power constraint field, wherein the transmit power constraint field has a value of 1, indicating that a “transmit power constraint” is applied to the power for transmitting the NDP by the sensing initiator. The sensing measurement report frame includes the constrained CSI.

In some embodiments, at least one field of “AGC gain constraint,” “transmit antenna radiation pattern constraint,” or “receive antenna radiation pattern constraint” is carried in at least one frame of the sensing measurement process for achieving constraint.

The AGC gain constraint is achieved by indicating to constrain the AGC gain for receiving the NDP by the sensing receiver; the transmit antenna radiation pattern constraint is achieved by indicating to constrain the antenna radiation pattern used for transmitting the NDP by the sensing transmitter; and the receive antenna radiation pattern constraint is achieved by indicating to constrain the antenna radiation pattern for receiving the NDP by the sensing receiver.

Those skilled in the art should understand the specific implementation of the above constraint methods, which is not repeated herein.

In summary, the methods provided in the present embodiments, by introducing at least one field of “transmit power constraint,” “AGC gain constraint,” “transmit antenna radiation pattern constraint,” or “receive antenna radiation pattern constraint,” constrains the impact of the change in at least one of a transmit power, a transmit antenna radiation pattern, a receive AGC gain, or a receive antenna radiation pattern on the sensing measurement result, thereby improving the accuracy of the sensing measurement result.

For better practice of the above technical solutions, the present disclosure further makes corresponding modifications to the relevant contents of the PHY service interface in the communication protocol, including modifications to thePHYCONFIG_VECTOR parameter and the TXVECTOR and RXVECTOR parameters.

### Modifications to the Physical Layer Configuration Vector (PHYCONFIG_VECTOR) Parameter

Two parameters are newly added in the parameter of PHYCONFIG_VECTOR that is defined in the extremely high-throughput (EHT), high-efficiency (HE), very high-throughput (VHT), and High-Throughput (HT) PHY section of the Institute of Electrical and Electronics Engineers (IEEE) 802.11 standard. The detailed modifications are as follows.

The following is added at the end of the 36.2.4 PHYCONFIG_VECTOR section:

The PHYCONFIG_VECTOR carried in the PHY-CONFIG.request primitive of the EHT PHY includes an AGC_CONSTRAINT parameter that indicates whether the AGC gains for receiving multiple subsequent NDPs are possible to change. In some embodiments, 1 means yes and 0 means no; or, 0 means yes and 1 means no.

The PHYCONFIG_VECTOR carried in the PHY-CONFIG.request primitive of the EHT PHY includes an RX_ANTENNA_PATTERN_CONSTRAINT parameter that indicates whether the receive antenna radiation pattern gains for receiving subsequent multiple NDPs are possible to change. In some embodiments, “0” means no and “1” means yes; or, “0” means yes and “1” means No.

The following are added at the end of the 27.2.4 PHYCONFIG_VECTOR parameters section:

The PHYCONFIG_VECTOR carried in the PHY-CONFIG.request primitive of the HE PHY includes an AGC_CONSTRAINT parameter that indicates whether the AGC gains for receiving multiple subsequent NDPs are possible to change. In some embodiments, “0” means no and “1” means Yes; or, “0” means Yes and “1” means No.

The PHYCONFIG_VECTOR carried in the PHY-CONFIG.request primitive of the HE PHY includes an RX_ANTENNA_PATTERN_CONSTRAINT that indicates whether the receive antenna radiation pattern gains for receiving the subsequent multiple NDPs are possible to change. In some embodiments, “0” means no and “1” means Yes; or, “0” means yes and “1” means No.

The following are added at the end of the 21.2.3 PHYCONFIG_VECTOR parameters section:

The PHYCONFIG_VECTOR carried in the PHY-CONFIG.request primitive of the VHT PHY includes an AGC_CONSTRAINT parameter that indicates whether the AGC gains for receiving subsequent NDPs are possible to change. In some embodiments, “0” means No and “1” means Yes; or, “0” means Yes and “1” means No.

The PHYCONFIG_VECTOR carried in the PHY-CONFIG.request primitive of the VHT PHY includes a RX_ANTENNA_PATTERN_CONSTRAINT parameter that indicates whether the receive antenna radiation pattern gains for receiving subsequent multiple NDPs are possible to change. In some embodiments, “0” means No and “1” means Yes; or, “0” means Yes and “1” means No.

The following are added at the end of the 19.2.3 PHYCONFIG_VECTOR parameters section:

The PHYCONFIG_VECTOR carried in the PHY-CONFIG.request primitive of the HT PHY includes an AGC_CONSTRAINT parameter that indicates whether the AGC gains for receiving subsequent NDPs are possible to change. In some embodiments, “0” means No and “1” means Yes; or, “0” means Yes and “1” means No.

The PHYCONFIG_VECTOR carried in the PHY-CONFIG.request primitive of the HT PHY includes a RX_ANTENNA_PATTERN_CONSTRAINT parameter that indicates whether the receive antenna radiation pattern gains for receiving subsequent multiple NDPs are possible to change. In some embodiments, “0” means No and “1” means Yes; or, “0” means Yes and “1” means No.

### MODIFICATIONS to the Sensing Transmitter Vector (TXVECTOR) and Sensing Receiver Vector (RXVECTOR) Parameters:

A new parameter AGC_GAIN is added to the corresponding tables in the EHT, HE, VHT, and HT PHY sections of the IEEE 802.11 standard. The detailed modifications are as follows.

A new parameter AGC_GAIN is added to Table 36-1 in the EHT PHY section of IEEE 802.11, as shown in Table 19.

TABLE 19
TXVECTOR and RXVECTOR Parameters

| Parameter | Condition | Value | TXVECTOR | RXVECTOR |
|---|---|---|---|---|
| AGC_GAIN | The format is | Values of AGC_GAIN parameter | N | Y |
| | EHT_MU or | range from [0, 80], and the | | |
| | EHT_TB | parameter is an AGC gain value for | | |
| | | receiving the EHT-LTF field of a | | |
| | | current PPDU by a PHY layer. | | |

| | |
|---|---|
| Other | Refer to the corresponding items in Table 27-1 in IEEE 802.11. |

A new parameter AGC_GAIN is added to Table 27-1 in the HE PHY section of IEEE 802.11, as shown in Table 20.

TABLE 20
TXVECTOR and RXVECTOR Parameters

| Parameter | Condition | Value | TXVECTOR | RXVECTOR |
|---|---|---|---|---|
| AGC_GAIN | The format is | Values of AGC_GAIN parameter | N | Y |
| | HE_SU, | range from [0, 80], and the | | |
| | HE_ER_SU, | parameter is an AGC gain value for | | |
| | HE_MU, or | receiving the HE-LTF field of a | | |
| | HE_TB | current PPDU by a PHY layer. | | |

| | |
|---|---|
| Other | Refer to the corresponding items in Table 21-1 in IEEE 802.11. |

A new parameter AGC_GAIN is added to Table 21-1 in the VHT PHY section of IEEE 802.11, as shown in Table 21.

TABLE 21
TXVECTOR and RXVECTOR Parameters

| Parameter | Condition | Value | TXVECTOR | RXVECTOR |
|---|---|---|---|---|
| AGC_GAIN | The format is | Values of AGC_GAIN parameter | N | Y |
| | VHT | range from [0, 80], and the parameter | | |
| | | is an AGC gain value for receiving | | |
| | | the VHT-LTF field of a current | | |
| | | PPDU by a PHY layer. | | |

| | |
|---|---|
| Other | Refer to the corresponding items in Table 19-1 in IEEE 802.11. |

A new parameter AGC_GAIN is added to Table 19-1 in the VHT PHY section of IEEE 802.11, as shown in Table 22.

TABLE 22
TXVECTOR and RXVECTOR Parameters

| Parameter | Condition | Value | TXVECTOR | RXVECTOR |
|---|---|---|---|---|
| AGC_GAIN | The format is | Values of AGC_GAIN parameter | N | Y |
| | HT_MF, or | range from [0, 80], and the parameter | | |
| | HT_GF | is an AGC gain value for receiving | | |
| | | the HT-LTF field of a current PPDU | | |
| | | by a PHY layer. | | |

| | |
|---|---|
| Other | No such case |

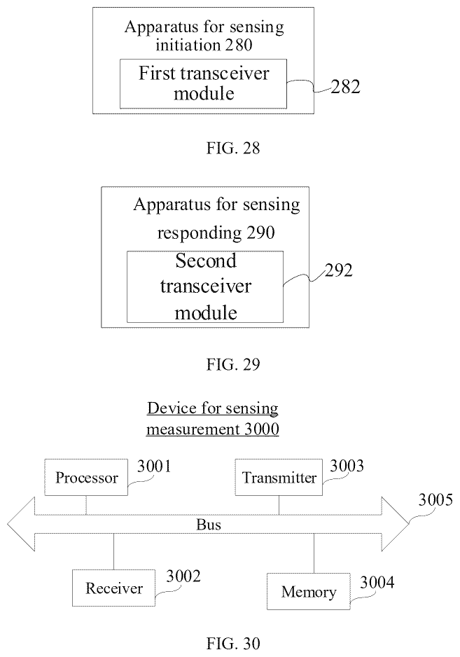

FIG. 28 is a structural block diagram of an apparatus for sensing initiation 280 according to some embodiments of the present disclosure. The apparatus 280 includes at least some of the following modules:
a first transceiver module 282, configured to transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

In some embodiments of the present disclosure, the target information is configured to eliminate or compensate for an impact of a change in at least one of the transmit power, the receive AGC gain, the transmit antenna radiation pattern, or the receive antenna radiation pattern on a sensing measurement result.

In some embodiments of the present disclosure, the first transceiver module 282 is further configured to perform at least one of:
transmitting a first frame at a sensing measurement setup stage, the first frame carrying the target information;
transmitting a second frame at a sensing measurement stage, the second frame carrying the target information; or
receiving a third frame at a sensing measurement report stage, the third frame carrying the target information.

In some embodiments of the present disclosure, the first transceiver module 282 is configured to receive or transmit the target information, wherein the target information is carried in at least one frame of the sensing measurement setup stage, and at least one frame of the sensing measurement setup stage carries at least one of the following first fields:
a transmit power constraint field, indicating whether to constrain the transmit power for transmitting the NDP;
an AGC gain constraint field, indicating whether to constrain the AGC gain for receiving the NDP;
a transmit antenna radiation pattern constraint field, indicating whether to constrain the transmit antenna radiation pattern for the NDP;
a receive antenna radiation pattern constraint field, indicating whether to constrain the receive antenna radiation pattern for the NDP;
an I2R transmit power CSI compensation mode field, indicating a compensation mode of compensating the CSI acquired by I2R measurements based on the change in a transmit power of the NDP;
an R2I transmit power CSI compensation mode field, indicating a compensation mode of compensating the CSI acquired by R2I measurements based on the change in a transmit power of the NDP; or
an AGC gain CSI compensation mode field, indicating a compensation mode of compensating the CSI acquired by I2R measurements based on the changes in AGC gain.

In some embodiments of the present disclosure, a compensation mode indicated by the I2R transmit power CSI compensation mode field includes any of:
no compensation;
sensing responder transmit power CSI compensation; or
sensing initiator transmit power CSI compensation.

The sensing responder transmitting power CSI compensation refers to a compensation mode in which the sensing initiator transmits the transmit power for transmitting an NDP to the sensing responder, and the sensing initiator receives compensated CSI from the sensing responder, wherein the compensated CSI is acquired by compensating for the measured CSI based on the transmit power of the NDP by the sensing responder.

In some embodiments of the present disclosure, the sensing initiator transmit power CSI compensation refers to a compensation mode in which the sensing initiator stores the transmit power of an NDP, receives the CSI from the sensing responder, and compensates for the CSI from the sensing responder based on the stored transmit power of the NDP.

In some embodiments of the present disclosure, a compensation mode indicated by the R2I transmit power CSI compensation mode field includes any one of:
no compensation;
compensation by specifying an R2I transmit power by the sensing initiator; or
compensation by feeding back an R2I transmit power by the sensing responder.

In some embodiments of the present disclosure, the compensation by specifying an R2I transmit power by the sensing initiator refers to a compensation mode in which a compensation mode in which the sensing initiator transmits a specified transmit power of an NDP to the sensing responder, receives the NDP from the sensing responder based on the specified transmit power, and compensates for measured CSI based on the specified transmit power.

In some embodiments of the present disclosure, the compensation by feeding back the R2I transmit power by the sensing responder refers to a compensation mode in which a sensing transmitter receives a transmit power of an NDP from the sensing responder, and compensates for measured CSI based on the transmit power of the NDP.

In some embodiments of the present disclosure, a compensation mode indicated by the AGC gain CSI compensation mode field comprises any one of:
no compensation;
sensing responder AGC gain CSI compensation; or
sensing initiator AGC gain CSI compensation.

In some embodiments of the present disclosure, the sensing responder AGC gain CSI compensation refers to a compensation mode in which the sensing initiator receives compensated CSI from the sensing responder, wherein the compensated CSI is acquired by the sensing responder by compensating for measured CSI based on an AGC gain for receiving an NDP.

In some embodiments of the present disclosure, the sensing initiator AGC gain CSI compensation refers to a compensation mode in which the sensing initiator receives an AGC gain from the sensing responder, wherein the AGC gain is an AGC gain used by the sensing responder for receiving an NDP; and the sensing initiator compensates for measured CSI based on the AGC gain and reference CSI.

In some embodiments of the present disclosure, the first frame comprises a sensing measurement setup request frame.

In some embodiments of the present disclosure, the first field is carried in a sensing measurement parameter element of the first frame.

In some embodiments of the present disclosure, the second frame carries at least one second field of:
a first sensing initiator-to-sensing responder I2R transmit power field; or
a first sensing responder-to-sensing initiator R2I transmit power field.

In some embodiments of the present disclosure, in the case that the I2R transmit power CSI compensation mode field indicates a compensation mode of sensing responder transmit power CSI compensation, the first I2R transmit power field indicates a transmit power of I2R in a sensing measurement instance associated with a sensing measurement instance identity ID; or

in the case that the I2R transmit power CSI compensation mode field indicates a compensation mode of no compensation or sensing initiator transmit power CSI compensation, the first I2R transmit power field is a reserved field.

In some embodiments of the present disclosure, in the case that the R2I transmit power CSI compensation mode field indicates a compensation mode of compensation by specifying R2I transmit power by the sensing initiator, the first R2I transmit power field indicates a transmit power of R2I in a sensing measurement instance associated with a sensing measurement instance ID; or
in the case that the R2I transmit power CSI compensation mode field indicates a compensation mode of no compensation or compensation by feeding back the R2I transmit power by the sensing responder, the first R2I transmit power field is a reserved field.

In some embodiments of the present disclosure, the second frame comprises at least one frame of:
a sensing measurement announcement frame; or
a ranging announcement frame carrying an identification field, wherein the identification field indicates that the ranging announcement frame is a sensing announcement frame for sensing.

In some embodiments of the present disclosure, the third frame carries at least one third field of:
a second sensing responder-to-sensing initiator measurement frame R2I transmit power field;
an AGC gain field; or
a reference CSI type field.

In some embodiments of the present disclosure, in the case that the R2I transmit power CSI compensation mode field indicates a compensation mode of compensation by feeding back an R2I transmit power by the sensing responder, the second R2I transmit power field indicates a transmit power of R2I in a sensing measurement instance associated with a sensing measurement instance identity ID or transmit power of R2I associated with a set of reference channel state information CSI; or
in the case that the R2I transmit power CSI compensation mode field indicates a compensation mode of no compensation or compensation by specifying an R2I transmit power by the sensing initiator, the second R2I transmit power field is a reserved field.

In some embodiments of the present disclosure, in the case that the AGC gain CSI compensation mode field indicates a compensation mode of sensing initiator AGC gain CSI compensation, the AGC gain field indicates an AGC gain for receiving an NDP by the sensing responder in a sensing measurement instance associated with a sensing measurement instance ID or an NDP receive AGC gain associated with a set of reference CSI; or
in the case that the AGC gain CSI compensation mode field indicates a compensation mode of no compensation or sensing responder AGC gain CSI compensation, the AGC gain field is a reserved field.

In some embodiments of the present disclosure, in the case that the R2I transmit power CSI compensation mode indicates a compensation mode of compensation by feeding back an R2I transmit power by the sensing responder, and/or the AGC gain CSI compensation mode field indicates a compensation mode of sensing initiator AGC gain CSI compensation, the reference CSI type field indicates actual measured CSI, reference CSI associated with the R2I transmit power, or reference CSI associated with an AGC gain; or
in the case that the R2I transmit power CSI compensation mode indicates a compensation mode of no compensation or compensation by specifying the R2I transmit power by the sensing initiator, and the AGC gain CSI compensation mode field indicates a compensation mode of no compensation or sensing responder AGC gain CSI compensation, the reference CSI type field is a reserved field.

In some embodiments of the present disclosure, the third frame carries a confidence field or a confidence level field; wherein
the confidence field indicates confidence in determining a result of a current sensing measurement as an accurate measurement result; and
the confidence level field indicates a level of confidence in determining the result of the current sensing measurement as an accurate measurement result.

In some embodiments, the format of the field includes at least one of a signed integer or an unsigned integer. In some embodiments, a plurality of bits occupied by the field form a plurality of code points, the plurality of code points including a first portion of code points and a second portion of code points, wherein each code point in the first portion of code points indicates a value of the confidence, and the second portion of code points indicates whether the value of the confidence is present and/or reserved. In other embodiments, the plurality of bits occupied by the field include a first portion of bits and a second portion of bits, the code point formed by the first portion of bits indicates the value of the confidence, and the second portion of bits indicates whether the value of the confidence is present, which is not limited in the embodiments of the present disclosure.

In some embodiments of the present disclosure, the first transceiver module 282 is configured to carry the target information in at least one frame transmitted between a physical PHY layer and a medium access control MAC layer.

In some embodiments of the present disclosure, the first transceiver module 282 is configured to carry the target information in at least one frame transmitted between the PHY layer and the MAC layer, which includes at least one of:
carrying at least one parameter of an AGC constraint parameter or a receive antenna radiation pattern constraint parameter in a PHY layer configuration vector carried in a PHY layer configuration request primitive transmitted from the MAC layer to the PHY layer;
carrying an AGC gain parameter in a transmit vector transmitted from the MAC layer to the PHY layer; or
carrying the AGC gain parameter in a receive vector transmitted from the PHY layer to the MAC layer.

It is to be noted that each of the above embodiments or each of the above technical features may also be combined in two or more combinations according to the needs of the person skilled in the art, which is not repeated herein.

In summary, according to the apparatus for sensing measurement provided by the present embodiments, by carrying target information related to at least one of the transmit power, the receive AGC gain, the transmit antenna radiation pattern, or the receive antenna radiation pattern in at least one frame during the sensing measurement process, the impact of at least one of the transmit power, the receive AGC gain, the transmit antenna radiation pattern, or the receive antenna radiation pattern on the sensing measurement result is eliminated or compensated for, which enables the sensing measurement system to more accurately sense changes in the physical channel.

FIG. 29 is a structural block diagram of an apparatus for sensing responding 290 according to some embodiments of the present disclosure. The apparatus 290 includes at least some of the following modules:
a second transceiver module 292, configured to receive and/or transmit at least one frame carrying target information during a sensing measurement process, wherein the target information is related to at least one of a transmit power, a receive automatic gain control AGC gain, a transmit antenna radiation pattern, or a receive antenna radiation pattern.

In some embodiments of the present disclosure, the target information is configured to eliminate or compensate for an impact of a change in at least one of the transmit power, the receive AGC gain, the transmit antenna radiation pattern, or the receive antenna radiation pattern on a sensing measurement result.

In some embodiments of the present disclosure, receiving and/or transmitting the at least one frame carrying the target information during the sensing measurement process includes at least one of:
receiving a first frame at a sensing measurement setup stage, the first frame carrying the target information;
receiving a second frame at a sensing measurement stage, the second frame carrying the target information; or
transmitting a third frame at a sensing measurement report stage, the third frame carrying the target information.

In some embodiments of the present disclosure, the first frame carries at least one first field of:
a transmit power constraint field;
an AGC gain constraint field;
a transmit antenna radiation pattern constraint field;
a receive antenna radiation pattern constraint field;
a sensing initiator-to-sensing responder I2R transmit power channel state information CSI compensation mode field;
a sensing responder-to-sensing initiator R2I transmit power CSI compensation mode field; or
an AGC gain CSI compensation mode field.

In some embodiments of the present disclosure, a compensation mode indicated by the I2R transmit power CSI compensation mode field comprises any one of:
no compensation;
sensing responder transmit power CSI compensation; or
sensing initiator transmit power CSI compensation.

In some embodiments of the present disclosure, the sensing responder transmit power CSI compensation refers to a compensation mode in which the sensing initiator transmits transmit power of an NDP to the sensing responder, and receives compensated CSI from the sensing responder, wherein the compensated CSI is acquired by the sensing responder by compensating for measured CSI based on the transmit power of the NDP.

In some embodiments of the present disclosure, the sensing initiator transmit power CSI compensation refers to a compensation mode in which the sensing initiator stores a transmit power of an NDP, receives CSI from the sensing responder, and compensates for the CSI from the sensing responder based on the stored transmit power of the NDP.

In some embodiments of the present disclosure, a compensation mode indicated by the R2I transmit power CSI compensation mode field comprises any one of:
no compensation;
compensation by specifying an R2I transmit power by the sensing initiator; or
compensation by feeding back an R2I transmit power by the sensing responder.

In some embodiments of the present disclosure, the compensation by specifying the R2I transmit power by the sensing initiator refers to a compensation mode in which the sensing initiator transmits a specified transmit power of an NDP to the sensing responder, receives the NDP from the sensing responder based on the specified transmit power, and compensates for measured CSI based on the specified transmit power.

In some embodiments of the present disclosure, the compensation by feeding back the R2I transmit power by the sensing responder refers to a compensation mode in which the sensing initiator receives a transmit power of an NDP from the sensing responder, and compensates for measured CSI based on the transmit power of the NDP.

In some embodiments of the present disclosure, a compensation mode indicated by the AGC gain CSI compensation mode field comprises any one of:
no compensation;
sensing responder AGC gain CSI compensation; or
sensing initiator AGC gain CSI compensation.

In some embodiments of the present disclosure, the sensing responder AGC gain CSI compensation refers to a compensation mode in which the sensing initiator receives compensated CSI from the sensing responder, wherein the compensated CSI is acquired by the sensing responder by compensating for measured CSI based on an AGC gain for receiving an NDP.

In some embodiments of the present disclosure, the sensing initiator AGC gain CSI compensation refers to a compensation mode in which the sensing initiator receives an AGC gain from the sensing responder, wherein the AGC gain is an AGC gain used by the sensing responder in receiving an NDP; and the sensing initiator compensates for measured CSI based on the AGC gain and reference CSI.

In some embodiments of the present disclosure, the first frame comprises a sensing measurement setup request frame.

In some embodiments of the present disclosure, the first field is carried in a sensing measurement parameter element of the first frame.

In some embodiments of the present disclosure, the second frame carries at least one second field of:
a first sensing initiator-to-sensing responder I2R transmit power field; or
a first sensing responder-to-sensing initiator R2I transmit power field.

In some embodiments of the present disclosure, in the case that the I2R transmit power CSI compensation mode field indicates a compensation mode of sensing responder transmit power CSI compensation, the first I2R transmit power field indicates a transmit power of I2R in a sensing measurement instance associated with a sensing measurement instance identity ID; or
in the case that the I2R transmit power CSI compensation mode field indicates a compensation mode of no compensation or sensing initiator transmit power CSI compensation, the first I2R transmit power field is a reserved field.
In some embodiments of the present disclosure, in the case that the R2I transmit power CSI compensation mode field indicates a compensation mode of compensation by specifying an R2I transmit power by the sensing initiator, the first R2I transmit power field indicates a transmit power of R2I in a sensing measurement instance associated with a sensing measurement instance ID; or
in the case that the R2I transmit power CSI compensation mode field indicates a compensation mode of no compensation or compensation by feeding back the R2I transmit power by the sensing responder, the first R2I transmit power field is a reserved field.

In some embodiments of the present disclosure, the second frame comprises at least one frame of:
a sensing measurement announcement frame; or
a ranging announcement frame carrying an identification field, wherein the identification field indicates that the ranging announcement frame is a sensing announcement frame for sensing.

In some embodiments of the present disclosure, the third frame carries at least one third field of:
a second sensing responder-to-sensing initiator measurement frame R2I transmit power field;
an AGC gain field; or
a reference CSI type field.

In some embodiments of the present disclosure, in the case that the R2I transmit power CSI compensation mode field indicates a compensation mode of compensation by feeding back an R2I transmit power by the sensing responder, the second R2I transmit power field indicates a transmit power of R2I in a sensing measurement instance associated with a sensing measurement instance identity ID or transmit power of R2I associated with a set of reference channel state information CSI; or
in the case that the R2I transmit power CSI compensation mode field indicates a compensation mode of no compensation or compensation by specifying the R2I transmit power by the sensing initiator, the second R2I transmit power field is a reserved field.

In one embodiment of the present disclosure, in the case that the AGC gain CSI compensation mode field indicates a compensation mode of sensing initiator AGC gain CSI compensation, the AGC gain field indicates an AGC gain for receiving an NDP by the sensing responder in a sensing measurement instance associated with a sensing measurement instance ID or an NDP receive AGC gain associated with a set of reference CSI; or
in the case that the AGC gain CSI compensation mode field indicates a compensation mode of no compensation or sensing responder AGC gain CSI compensation, the AGC gain field is a reserved field.

In some embodiments of the present disclosure, in the case that the R2I transmit power CSI compensation mode indicates a compensation mode of compensation by feeding back an R2I transmit power by the sensing responder, and/or the AGC gain CSI compensation mode field indicates a compensation mode of sensing initiator AGC gain CSI compensation, the reference CSI type field indicates actual measured CSI, reference CSI associated with the R2I transmit power, or reference CSI associated with an AGC gain; or
in the case that the R2I transmit power CSI compensation mode indicates a compensation mode of no compensation or compensation by specifying the R2I transmit power by the sensing initiator, and the AGC gain CSI compensation mode field indicates a compensation mode of no compensation or sensing responder AGC gain CSI compensation, the reference CSI type field is a reserved field.

In some embodiments of the present disclosure, the third frame carries a confidence field or a confidence level field; wherein
the confidence field indicates confidence in determining a result of a current sensing measurement as an accurate measurement result; and
the confidence level field indicates a level of confidence in determining the result of the current sensing measurement as an accurate measurement result.

In some embodiments, the format of the field includes at least one of a signed integer or an unsigned integer. In some embodiments, a plurality of bits occupied by the field form a plurality of code points, the plurality of code points including a first portion of code points and a second portion of code points, wherein each code point in the first portion of code points indicates a value of the confidence, and the second portion of code points indicates whether the value of the confidence is present and/or reserved. In other embodiments, the plurality of bits occupied by the field include a first portion of bits and a second portion of bits, the code point formed by the first portion of bits indicates the value of the confidence, and the second portion of bits indicates whether the value of the confidence is present, which is not limited in the embodiments of the present disclosure.

In some embodiments of the present disclosure, the second transceiver module 292 is configured to carry the target information in at least one frame transmitted between a physical PHY layer and a medium access control MAC layer.

In some embodiments of the present disclosure, the second transceiver module 292 is configured to carry the target information in at least one frame transmitted between the PHY layer and the MAC layer, which includes at least one of:
carrying at least one parameter of an AGC constraint parameter or a receive antenna radiation pattern constraint parameter in a PHY layer configuration vector carried in a PHY layer configuration request primitive transmitted from the MAC layer to the PHY layer;
carrying an AGC gain parameter in a receive vector transmitted from the PHY layer to the MAC layer; or
carrying the AGC gain parameter in a transmit vector transmitted from the MAC layer to the PHY layer.

It is to be noted that each of the above embodiments or each of the above technical features may also be combined in two or more combinations according to the needs of the person skilled in the art, which is not repeated herein.

In summary, according to the apparatus for sensing measurement provided by the present embodiments, by carrying target information related to at least one of the transmit power, the receive AGC gain, the transmit antenna radiation pattern, or the receive antenna radiation pattern in at least one frame during the sensing measurement process, the impact of at least one of the transmit power, the receive AGC gain, the transmit antenna radiation pattern, or the receive antenna radiation pattern on the sensing measurement result is eliminated or compensated for, which enables the sensing measurement system to more accurately sense changes in the physical channel.

It is to be noted that the apparatuses provided in the above embodiments are only illustrated using the division of the above-described functional modules as an example, and in actual application, the above-described functions are possible to be accomplished by different functional modules according to actual needs. That is, the internal structure of the apparatus is possible to be divided into different functional modules to accomplish all or part of the above-described functions.

With respect to the apparatus in the present embodiments, the specific implementations of the various modules to complete operations have been described in detail in the method embodiments and are not described in detail herein.

FIG. 30 is a structural schematic diagram of a device for sensing measurement according to some embodiments of the present disclosure. The device for sensing measurement 3000 includes a processor 3001, a receiver 3002, a transmitter 3003, a memory 3004, and a bus 3005.

The processor 3001 includes one or more processing cores, and the processor 3001 performs various functional applications as well as information processing by running one or more software programs and modules.

In some embodiments, the receiver 3002 and the transmitter 3003 are implemented as a communication component, which is a communication chip in some embodiments.

The memory 3004 is connected to the processor 3001 via a bus 3005. The memory 3004 is configured to store one or more instructions, and the processor 3001, when loading and running the one or more instructions, is caused to perform the various processes in the method embodiments described above.

In addition, in some embodiments, the memory 3004 is implemented by any type of transitory or non-transitory storage device or a combination thereof, the transitory or non-transitory storage devices including, but not limited to: a magnetic disk or optical disk, an electrically erasable programmable read-only memory(EEPROM), an erasable programmable read-only memory (EPROM), a static random-access memory (SRAM), a read-only memory (ROM), a magnetic memory, a flash memory, or a programmable read-only memory (PROM).

In some embodiments, a computer-readable storage medium is further provided. The computer-readable storage medium stores one or more segments of a program. The one or more segments of the program, when loaded and executed by a processor of a device, cause the device to perform the method for sensing measurement provided by the above method embodiments.

In some embodiments, a chip is further provided. The chip includes a programmable logic circuitry or one or more programs. The chip, when running on a communication device, causes the device to perform the method for sensing measurement provided by the above method embodiments.

In some embodiments, a computer program product is further provided. The computer program product, when running on a processor of a computer device, causes the computer device to perform the above-described method for sensing measurements.

It should be appreciated by those skilled in the art that, in one or more of the above embodiments, the functions described in the embodiments of the present disclosure can be implemented using hardware, software, firmware, or any combination thereof. In the case of implementing by software, the functions are stored in a computer-readable medium or transmitted as one or more instructions or codes on the computer-readable medium. The computer-readable media include computer storage media and communication media, wherein the communication media includes any medium that facilitates the transmission of a computer program from one location to another. The storage medium includes any usable medium to which a general-purpose or specialized computer has access.

The foregoing are only exemplary embodiments of this disclosure and are not intended to limit this disclosure, and any modifications, equivalent substitutions, improvements, etc., made within the concept and principles of the disclosure shall be included in the scope of protection of the disclosure.

1. A device for sensing initiation, comprising:
a processor;
a transceiver connected to the processor; and
a memory configured to store one or more executable instructions, which when executed by the processor, cause the device for sensing initiation to:
transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

2. The device for sensing initiation according to claim 1, wherein the target information is configured to eliminate or compensate for an impact of a change in at least one of the transmit power, the receive AGC gain, the transmit antenna radiation pattern, or the receive antenna radiation pattern on a sensing measurement result.

3. The device for sensing initiation according to claim 1, wherein the one or more executable instructions, which when executed by the processor, further cause the device for sensing initiation to perform at least one of:
transmitting a first frame at a sensing measurement setup stage, the first frame carrying the target information;
transmitting a second frame at a sensing measurement stage, the second frame carrying the target information; or
receiving a third frame at a sensing measurement report stage, the third frame carrying the target information.

4. The device for sensing initiation according to claim 3, wherein the first frame carries at least one first field of:
a transmit power constraint field;
an AGC gain constraint field;
a transmit antenna radiation pattern constraint field;
a receive antenna radiation pattern constraint field;
a sensing initiator-to-sensing responder I2R transmit power channel state information CSI compensation mode field;
a sensing responder-to-sensing initiator R2I transmit power CSI compensation mode field; or
an AGC gain CSI compensation mode field.

5. The device for sensing initiation according to claim 4, wherein the second frame carries at least one second field of:
a first sensing initiator-to-sensing responder I2R transmit power field; or
a first sensing responder-to-sensing initiator R2I transmit power field.

6. The device for sensing initiation according to claim 4, wherein the third frame carries at least one third field of:
a second sensing responder-to-sensing initiator measurement frame R2I transmit power field;
an AGC gain field; or
a reference CSI type field.

7. The device for sensing initiation according to claim 1, wherein the one or more executable instructions, which when executed by the processor, cause the device for sensing initiation to:
carry the target information in at least one frame transmitted between a physical PHY layer and a medium access control MAC layer.

8. A device for sensing responding, comprising:
a processor;
a transceiver connected to the processor; and
a memory configured to store one or more executable instructions, which when executed by the processor, cause the device for sensing responding to:
receive and/or transmit at least one frame carrying target information during a sensing measurement process, wherein the target information is related to at least one of a transmit power, a receive automatic gain control AGC gain, a transmit antenna radiation pattern, or a receive antenna radiation pattern.

9. The device for sensing responding according to claim 8, wherein the target information is configured to eliminate or compensate for an impact of a change in at least one of the transmit power, the receive AGC gain, the transmit antenna radiation pattern, or the receive antenna radiation pattern on a sensing measurement result.

10. The device for sensing responding according to claim 8, wherein the one or more executable instructions, which when executed by the processor, cause the device for sensing responding to perform at least one of:
receiving a first frame at a sensing measurement setup stage, the first frame carrying the target information;
receiving a second frame at a sensing measurement stage, the second frame carrying the target information; or
transmitting a third frame at a sensing measurement report stage, the third frame carrying the target information.

11. The device for sensing responding according to claim 10, wherein the first frame carries at least one first field of:
a transmit power constraint field;
an AGC gain constraint field;
a transmit antenna radiation pattern constraint field;
a receive antenna radiation pattern constraint field;
a sensing initiator-to-sensing responder I2R transmit power channel state information CSI compensation mode field;
a sensing responder-to-sensing initiator R2I transmit power CSI compensation mode field; or
an AGC gain CSI compensation mode field.

12. The device for sensing responding according to claim 11, wherein the second frame carries at least one second field of:
a first sensing initiator-to-sensing responder I2R transmit power field; or
a first sensing responder-to-sensing initiator R2I transmit power field.

13. The device for sensing responding according to claim 11, wherein the third frame carries at least one third field of:
a second sensing responder-to-sensing initiator measurement frame R2I transmit power field;
an AGC gain field; or
a reference CSI type field.

14. The device for sensing responding according to claim 8, wherein the one or more executable instructions, which when executed by the processor, cause the device for sensing responding to:
carry the target information in at least one frame transmitted between a physical PHY layer and a medium access control MAC layer.

15. A chip, comprising:
a programmable logic circuitry or one or more programs;
wherein a sensing measurement device equipped with the chip is configured to:
transmit and/or receive at least one frame carrying target information during a sensing measurement process, wherein the target information is related to at least one of a transmit power, a receive automatic gain control AGC gain, a transmit antenna radiation pattern, or a receive antenna radiation pattern.

16. The chip according to claim 15, wherein the target information is configured to eliminate or compensate for an impact of a change in at least one of the transmit power, the receive AGC gain, the transmit antenna radiation pattern, or the receive antenna radiation pattern on a sensing measurement result.

17. The chip according to claim 15, wherein the sensing measurement device equipped with the chip is configured to perform at least one of:
transmitting a first frame at a sensing measurement setup stage, the first frame carrying the target information;
transmitting a second frame at a sensing measurement stage, the second frame carrying the target information; or
receiving a third frame at a sensing measurement report stage, the third frame carrying the target information.

18. The chip according to claim 17, wherein the first frame carries at least one first field of:
a transmit power constraint field;
an AGC gain constraint field;
a transmit antenna radiation pattern constraint field;
a receive antenna radiation pattern constraint field;
a sensing initiator-to-sensing responder I2R transmit power channel state information CSI compensation mode field;
a sensing responder-to-sensing initiator R2I transmit power CSI compensation mode field; or
an AGC gain CSI compensation mode field.

19. The chip according to claim 18, wherein the second frame carries at least one second field of:
a first sensing initiator-to-sensing responder I2R transmit power field; or
a first sensing responder-to-sensing initiator R2I transmit power field.

20. The chip according to claim 18, wherein the third frame carries at least one third field of:
a second sensing responder-to-sensing initiator measurement frame R2I transmit power field;
an AGC gain field; or
a reference CSI type field.
